(19) United States
(12) Patent Application Publication
(10) Pub. No.: US 2025/0111457 A1
(43) Pub. Date: Apr. 3, 2025

(54) Judicial Support Tool Computing System

(71) Applicants: Northwestern University, Evanston, IL (US); The Trustees of Dartmouth College, Hanover, NH (US)

(72) Inventors: Venkatramanan Siva Subrahmanian, Evanston, IL (US); Sayak Chakrabarty, Evanston, IL (US); Maksim Bolonkin, Evanston, IL (US); Cristian Molinaro, Evanston, IL (US)

(21) Appl. No.: 18/901,646

(22) Filed: Sep. 30, 2024

Related U.S. Application Data
(60) Provisional application No. 63/541,555, filed on Sep. 29, 2023.

(51) Int. Cl. G06Q 50/18

(52) U.S. Cl. CPC G06Q 50/18

(57) ABSTRACT

Systems and methods described herein include a logical computing framework (JUST) within which judges can record propositions about a case and witness statements where a witness says that certain propositions are true. The logical computing framework may provide a user interface that allows the judge to assign a probability of her belief in a witness statement. For example, a world is an assignment of true or false to each proposition, which is required to satisfy case specific integrity constraints. The logical computing framework processes an explicit algorithm that calculates the k-most likely worlds without using independence assumptions between propositions. The judge may use these calculated top-k most probable worlds to make his or her final decision. For this computation, the logical computing framework incorporates and uses a suite of “combination” functions. Additionally, the logical computing framework incorporates an implicit and efficient algorithm.

### CROSS REFERENCE TO RELATED APPLICATION(S)

This is a utility application claiming priority to and incorporating by reference provisional application entitled “Judicial Support Tool Computing System”, Ser. No. 63/541,555 filed Sep. 29, 2023.

### BACKGROUND

According to a 2017 study, 11.7% of convictions in the US were wrong. In cases where DNA evidence was present, that number rose to 12.6%. K. Walsh, J. Hussemann, A. Flynn, J. Yahner, and L. Golian, “Estimating the prevalence of wrongful convictions,” https://www.ojp.gov/pdffiles1/nij/grants/251115.pdf, 2017. Further, according to a report (https://www.sentencingproject.org/publications/un-report-on-racial-disparities/) submitted to the UN, African-American adults are 5.9 times as likely to be incarcerated than whites and Hispanics are 3.1 times as likely (in the US). These findings portray fundamental flaws in the judicial process in the US. Because judges sometimes make mistakes, a need has been recognized for improved judicial analysis systems to improve and assist in judicial decisioning.

It is with these concepts in mind, among others, that various aspects of the present disclosure were conceived.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Some aspects described herein involve a system including a logical computing framework (JUST) within which judges or jury members can record propositions about a case and witness statements where a witness says that certain propositions are true. The logical computing framework may provide a user interface that allows the judge or jury members to assign a probability of her belief in a witness statement. A world is an assignment of true or false to each proposition, which is required to satisfy case specific integrity constraints. The logical computing framework employs an explicit algorithm that calculates the k-most likely worlds without using independence assumptions between propositions. The judge may use these calculated top-k most probable worlds to make his or her final decision. For this computation, the logical computing framework incorporates and uses a suite of “combination” functions. Additionally, the logical computing framework incorporates an implicit and efficient algorithm. As provided below, JUST has been tested using 10 combination functions on 5 real-world court cases and 19 TV court cases, where the illustrative examples show the combinations under which JUST works well in practice.

The details of these and other aspects of the disclosure are set forth in the accompanying drawings and description below. Other features and advantages of the disclosure will be apparent from the drawings and description.

### BRIEF DESCRIPTION OF THE DRAWINGS

The foregoing and other objects, features, and advantages of the present disclosure set forth herein will be apparent from the following description of particular embodiments of those inventive concepts, as illustrated in the accompanying drawings. Also, in the drawings the like reference characters refer to the same parts throughout the different views. The drawings depict only typical embodiments of the present disclosure and, therefore, are not to be considered limiting in scope.

FIG. 1 shows illustrative architecture of the JUST computing framework, according to aspects of the present disclosure;

FIG. 2 shows sample witness and assessment functions, according to aspects of the present disclosure;

FIGS. 3A-3F show prediction performance of algorithms implemented in the Just computing framework, according to aspects of the present disclosure;

FIGS. 4A-4F show prediction performance of algorithms implemented in the Just computing framework, according to aspects of the present disclosure;

FIGS. 5A and 5B show the average prediction performance as the number of considered possible worlds increases, according to aspects of the present disclosure;

FIGS. 6A and 6B show the distributions of the maximum prediction performance value reached by an implicit algorithm over all datasets, according to aspects of the present disclosure;

FIGS. 7A and 7B show distributions of the maximum prediction performance value reached by an implicit algorithm over all datasets according to aspects of the present disclosure;

FIGS. 8A and 8B show the average run time of an implicit algorithm across all datasets and combination functions as the number of possible world increases, according to aspects of the present disclosure;

FIGS. 9A-9L show prediction performance of the implicit algorithm—CF_{avg} vs. CFt^{rust}_{avg}, according to aspects of the present disclosure;

FIGS. 10A-10L show prediction performance of the implicit algorithm—CF_{avg} vs. CFt^{rust}_{avg}, according to aspects of the present disclosure;

FIGS. 11A-11F show prediction performance of the implicit algorithm—CFₘᵢₙ vs. CFt^{rust}ₘᵢₙ, according to aspects of the present disclosure; and

FIGS. 12A-12F show prediction performance of the implicit algorithm—CFₘₐₓ vs. CFt^{rust}ₘₐₓ, according to aspects of the present disclosure;

FIGS. 13A-13F show prediction performance of the implicit algorithm—CF_{mode} vs. CFt^{rust}_{mode}, according to aspects of the present disclosure;

FIGS. 14A-14F show prediction performance of the implicit algorithm—CF_{median} vs. CFt^{rust}_{median}, according to aspects of the present disclosure;

FIG. 15A shows a table of possible worlds for P={p1, p2, p3, p4} with a given probability distribution, according to aspects of the present disclosure;

FIG. 15B shows a table of illustrative runtimes of the implicit and explicit algorithms with CF_{avg}, according to aspects of the present disclosure; and

FIG. 16 shows an illustrative block diagram of a processor platform implementing at least the JUST computing framework of FIG. 1, according to aspects of the present disclosure.

### DETAILED DESCRIPTION

Aspects of the present disclosure relate to data science, evidence-based decision making and, more particularly to a software package and computing system enabled for assembling and encoding factual statements from witnesses, assigning probabilities of the statements to be truthful, automatically incorporating case-specific integrity constraints and using combination functions to render the k most probable worlds, and enabling a judge to issue a verdict based on the output of the system.

Judges sometimes might not reason logically, for example, a judge may be biased towards certain segments of the population (e.g., women, minorities, etc.). As such, the JUST computing framework allows judges to provide non-arbitrary decisions, thereby improving social justice. For example, analysis and operations performed by the JUST computing framework has the potential to reduce bias by making judges (or maybe juries) assign probabilities to witness statements. The computing system provides an automatic framework to allow judges' decisioning to be more logically well-founded based on probabilistic logic, and therefore the judges may provide more fair judgements. Output from the JUST computing framework may be presented to the judge. A user interface may present the most-likely scenarios generated based on the judge (or jury's) own assessment(s) and the laws of probability, where the automatically generated information may assist the judge make a better decision. At the very least, the judge will at least be presented with possible scenarios that conflict with what the judge may have in mind, thus leading to a better-informed final decision. In addition, the assessments provided via the JUST computing framework may be made part of the legal record, which can allow society to better monitor judicial bias. While reversing centuries of racial bias can be a challenge, the JUST computing framework's analysis and output may improve legal outcomes, and may make court procedures fairer.

The computing framework starts with witness statements and an assessment of the witness statements that the judge provides. The judge is then presented with the most likely scenarios based on the judge's own assessment (or the jury's assessment if the judge prefers that, or a combination of the judge and jury's assessment if that is preferable) and the laws of probability to assist in making a more grounded decision. The computing framework will allow the judge to see possible scenarios that conflict with what the judge may have previously had in their mind and, thus allow the judge to make a better-informed final decision. The computing framework may lead to better judicial decisions and reduce biasing problems. The attached Appendix entitled “Judicial Support Tool: Finding the k-Most Likely Judicial Worlds” highlights examples and details related to at least the structures and methods described herein and are incorporated by reference in its entirety herein.

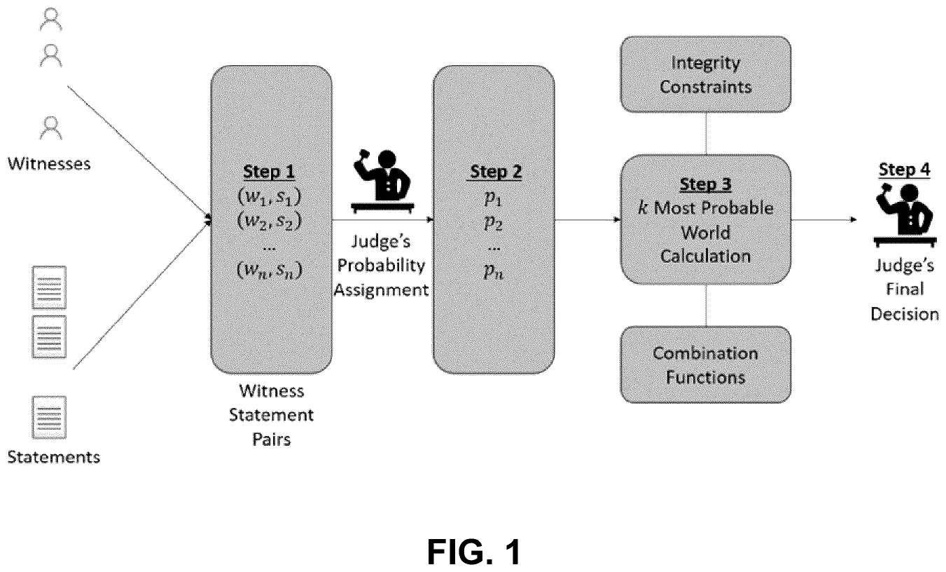

The systems and methods that implement the JUST computing framework assist judges and/or juries in considering the evidence more objectively. JUST proceeds in four broad steps, as shown in FIG. 1. For example, factual statements from witnesses may first be assembled and encoded. Second, the judge assigns probabilities of the statements to be truthful. This step may alternatively be done by the jury. Each jury member assigns probabilities of the statements to be truthful and the probability of the statement could be any meaningful value derived from these (e.g., the average, or the median, or the average after removing the lowest and highest probabilities assigned by jury members). Third, the JUST computing framework incorporates case-specific integrity constraints and uses combination functions to render the k-most probable worlds. And fifth, the judge (or jury) can issue a decision based on the output of the system. More specifically, in the first step, JUST encodes witness statements as propositions in logic.

This can be easily done, for example, when transcribing witness statements and depositions in, such as in US courtroom proceedings. To reduce dependence on biased decisioning from a judge (or jury), the judge and jury may independently assign probabilities, from which a median value may be used. In a second step, judges (or juries as indicated in [024]) can then use their own judgement to assign probabilities to whether those statements are true. In the third step, JUST would identify a space of k-possible worlds, along with their probabilities. These possible worlds will need to satisfy various integrity constraints. By showing these k possible worlds to a judge, JUST makes judges aware of different ways in which the evidence in the case can be viewed, along with the probabilities of those worlds based on the judge's own assessment function (or the jury's assessment function if that is preferred by the judge or a combination of the two). At the end of the day, the JUST computing framework allows the judge to make a final better-informed decision, while keeping in mind the alternative worlds presented to them by the JUST system.

A problem solved by JUST may first be defined with reference to a universe of propositions. In Step 1, a witness may say some propositions are true, others are false, and offer no opinion about some propositions. Witness testimony can conflict. A set of integrity constraints (ICs) is also specified sometime after Step 1 and before Step 3 can be executed. Possible worlds are interpretations in logic that satisfy the integrity constraints. In Step 2, judges can assign a probability to each witness statement denoting how much the judge believes a particular witness statement. For instance, in the famous Casey Anthony murder trial (https://en.wikipedia.org/wiki/Death of Caylee Anthony) in the US, Casey's father said “Casey sedated her daughter.” A judge may assign a 75% probability that the witness was telling the truth, while another witness might say the opposite and the judge (or jury) may assign a different probability to that witness's statement. The JUST computing framework uses a class of “combination functions” (CFs) to combine these probabilities and show that they induce probability distributions on the space of possible worlds in different ways. The JUST computing framework then presents two approximation algorithms to find the top-k most likely possible worlds, which can be presented to a judge (or jury) as options to consider before rendering a final decision. The JUST computing framework was tested with a prototype implementation of our framework and its performance was evaluated over 19 TV legal cases and 5 real-world court cases. The JUST computing framework was found to perform very well, achieving high prediction performance when comparing the ground truth and the top-k possible worlds.

Below, the framework is formally defined, the different “combination functions” to combine multiple witness statements are introduced, algorithms to compute most likely possible worlds are presented, and an experimental evaluation over several real-world cases is reported. The related work and conclusions are presented at the end.

### The Just Framework

Within the JUST computing framework, the existence of a set [symbol] of “sources” and a set [symbol] of (Boolean) propositions are assumed. For example, sources might be those who provided testimony about the Casey Anthony case. The propositions refer to the specific statements that they made, such as “Casey sedated her daughter Caylee.” Assume that [symbol] does not contain propositions with “complementary” meaning, e.g., p=“Casey sedated her daughter Caylee” and p′=“Casey did not sedate her daughter Caylee.” (Note that there is no loss of generality in this assumption as p′ can be modeled by assigning the truth value false to p, since p is a Boolean proposition that can take the truth values true or false. Moreover, court recording companies can easily ensure this when they produce transcripts and define propositions if they use a system like JUST). Witness functions, defined below, capture statements made by witnesses.

### Definition 1: (Witness Function)

A witness function is a partial mapping ω: [symbol] × [symbol] →{0,1}.

Intuitively, ω(s,p)=1 when source s said proposition p is true, while ω(s,p)=0 when s said p is false. Also, ω is a partial mapping, and ω(s,p) is not defined in cases when s did not say anything about p.

An assessment function provides a “confidence” for each statement by some source s about some proposition p. This assessment function reflects the judge's assessment of the veracity of a specific statement by a witness. It can easily be implemented via a graphical user interface in which the judge can log his degree of belief in witness's remarks on a specific statement.

### Definition 2 (Assessment Function)

An assessment function for a witness function ω is a partial mapping α: [symbol] × [symbol] →[0,1] such that for every source s∈ [symbol] and every proposition p∈ [symbol] , α(s,p) is defined iff ω(s,p) is defined.

Intuitively, α(s,p) returns a real value in [0,1] assessing the probability of belief that the judge has in s's statement about proposition p is true. For example, α(s,p)=0.7 says that the assessment function believes the statement by source s about proposition p is true with a confidence of 70%. Such assessment functions are provided by the judge or jury. It is important to note that if each member of the jury provides their own assessment of a statement s about proposition p by a specific witness, then these assessments can be combined by the JUST system in accordance with a preference expressed by the judge. Suppose there are 5 jurors who assign such a statement a probability of 0.5, 0.7, 0.3, 0.9, 1 respectively. The judge may combine these probabilities by taking their average which is 0.68. Or the judge may take the median of these probabilities which would be 0.7. Or the judge may take the average after eliminating the highest (e.g., 1) and lowest probability (e.g., 0.3) assignments, leading to a combined probability of 0.7. The reader will note that many other ways can be used by the judge to combine the probabilities provided by the jury members. Or he may choose to only use the probability he assigns to the witness statements or some combination of the jury members' assigned probabilities and his own.

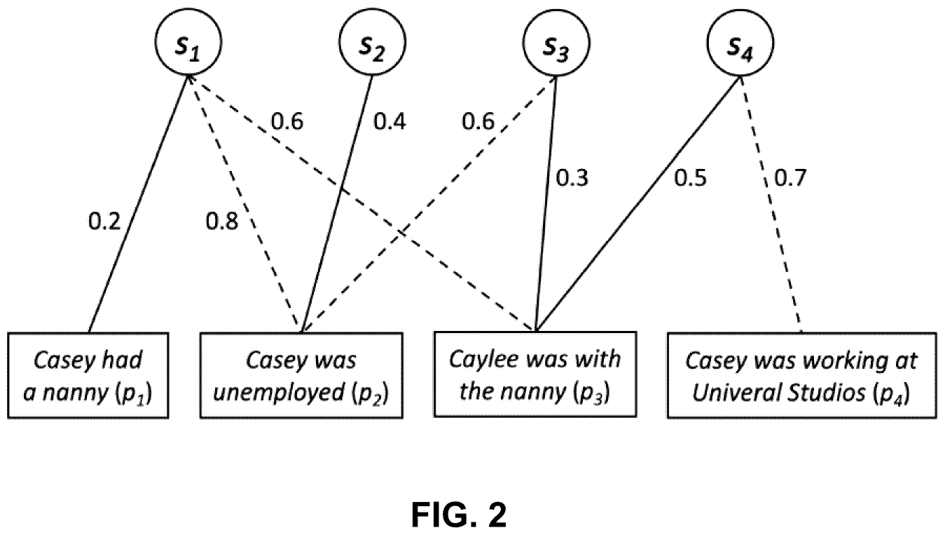

Example 1 FIG. 2 shows sample witness and assessment functions. Here, solid lines represent that a source said the corresponding proposition was true, dashed lines represent the source testifying that the proposition is false. Numbers represent the confidence in veracity of the statements made by sources. FIG. 2 shows a sample case (extracted from the Casey Anthony case) with 4 sources [symbol] ={s₁, . . . , s₄} and 4 propositions [symbol] ={p₁, . . . , p₄}, depicted as a bipartite graph. In Step 1, the witness function is captured by the edges connecting the sources to the propositions. A solid (resp., dashed) edge denotes ω(s,p)=1 (resp., ω(s,p)=0). The assessment function is captured via the edge weights. For example, the dashed edge from s₁ to p₃ with weight of 0.6 specifies that s₁ said that p₃ (namely, “Caylee was with the nanny”) is false, and the assessment function assesses s₁'s testimony to be true with 60% probability.

The notion of a possible world is one in which models one possible scenario that might have occurred.

### Definition 3 (Possible World)

A possible world is a total mapping γ: [symbol] →{0,1}.

Intuitively, a possible world labels every single proposition as being either true (1) or false (0). Use PW to denote the set of all possible worlds over [symbol] .

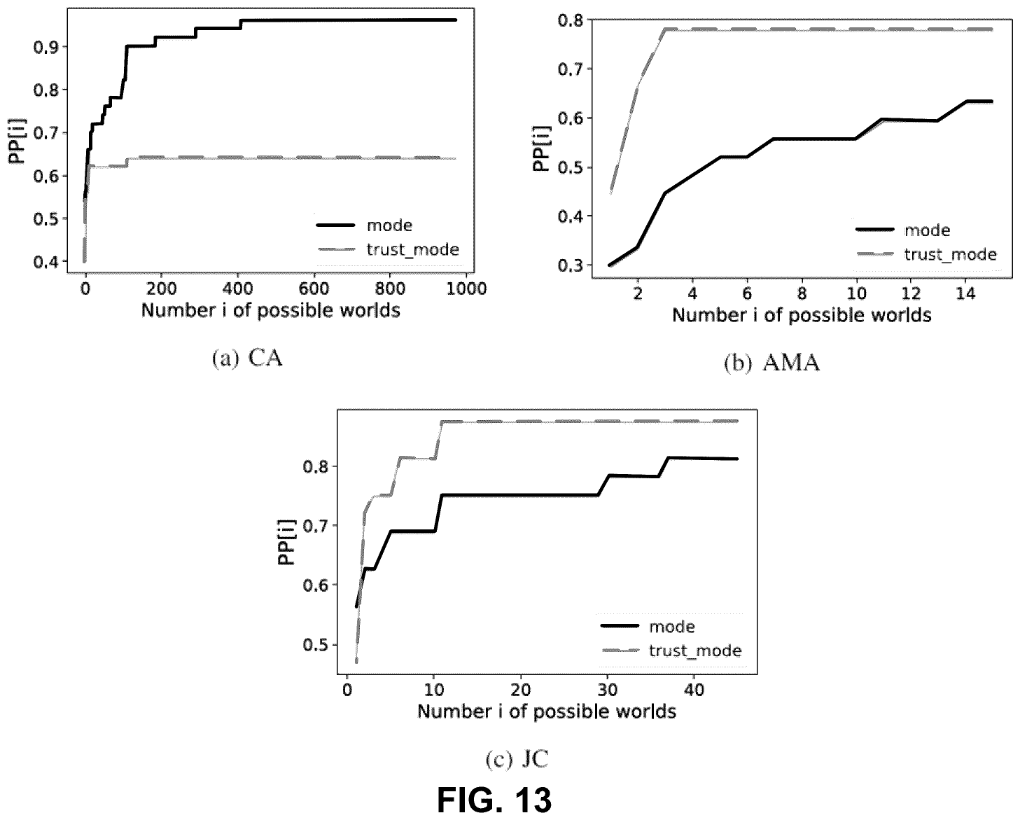

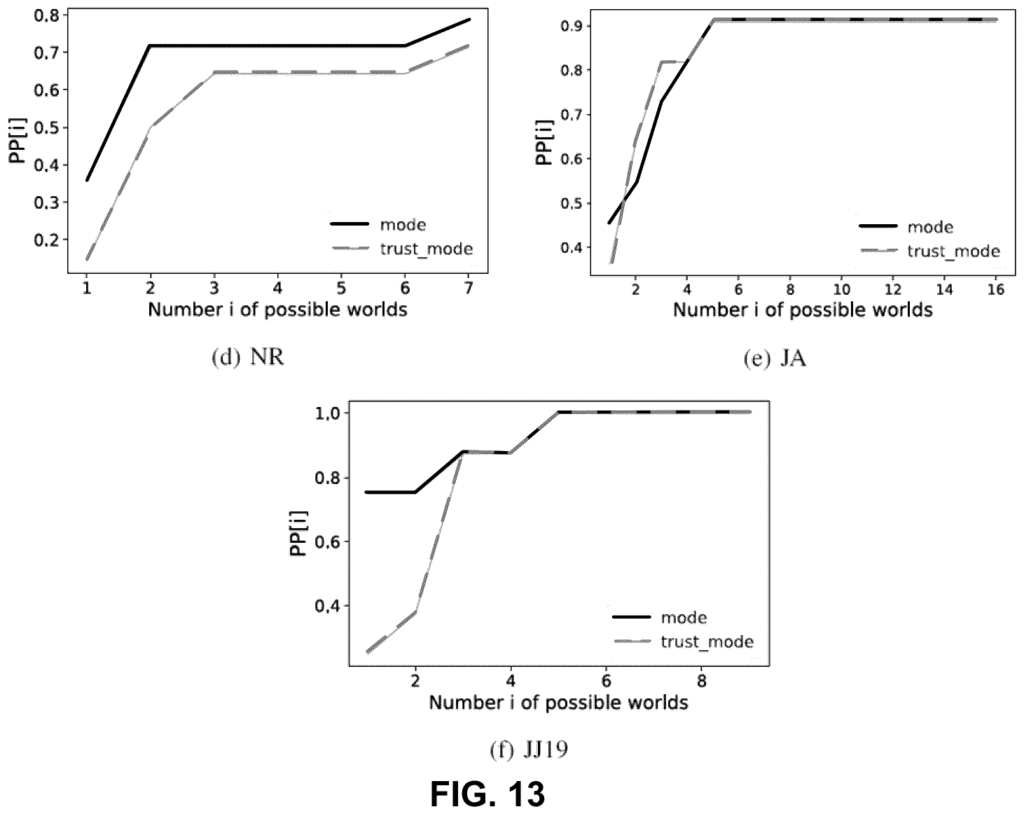

Example 2 The running example has 16 possible worlds, depending on whether the function assigns 0 or 1 to each of the four propositions. Table I, as shown in FIG. 13A, shows these worlds (the column Pic will be discussed later on). As an example, according to possible world γ₁₂, which assigns 1 (resp., 0) to p₁ and p₂ (resp., p₃ and p₄), Casey had a nanny, was unemployed, did not work at Universal Studios, and Caylee was not with the nanny (See, FIG. 2).

An important point to note from the above example is that the set of all possible worlds is exponential in the set of propositions. For instance, if there are 100 propositions, then there will be 2¹⁰⁰ possible worlds, e.g., 1267650600228229401496703205376 possible worlds. This will prove to be a major challenge in computing the k most probable worlds when discussed below.

In some real-world situations, partial or total ground truth may exist, but in situations like judicial cases, and in general in the presence of uncertainty, ground truth does not necessarily exist about what occurred and what did not occur. A possible world captures one possible scenario that might have occurred. To find the k-most probable words, all possible worlds must be considered. However, some of them may be inconsistent with the semantics (e.g., meaning) of the propositions considered. As usual, semantics of cases via two types of integrity constraints are captured, which are introduced below.

### Definition 4 (Denial Constraint)

A denial constraint is of the form ¬(p₁∧ . . . ∧pₙ), with n≥1 and each pᵢ∈ [symbol] .

Intuitively, a denial constraint says that the propositions p₁, . . . , pₙ cannot all be simultaneously true.

### Definition 5 (Definite Constraint)

A definite constraint is of the form p₁∧ . . . ≳pₙ→p₀, with n≥0 and each pᵢ∈ [symbol] .

Intuitively, a definite constraint says that if the propositions p₁, . . . , pₙ are all simultaneously true, then p₀ must be true. When n=0, then p₀ must be true.

Example 3 In the running example, the following two constraints may exist (referring to some fixed time point):

¬( “Casey was unemployed”(p2) ∧
“Casey was working at Universal Studios”(p4) )
“Caylee was with the nanny” (p3) → “Casey had a nanny”(p1)

The first is a denial constraint saying that “Casey was unemployed” and “Casey was working at Universal Studios” cannot both be true at the same time. The second is a definite constraint saying that if “Caylee was with the nanny” is true, then ‘Casey had a nanny” must also be true. (Note—A simple graphical user interface or GUI can enable court transcription companies to easily write the propositions and the ICs in English as has been done in the Casey Anthony examples, so personnel only need to know how to use the GUI and not have to know logic.)

Define what it means for a possible world to satisfy a given integrity constraint.

### Definition 6 (Satisfaction)

A possible world γ satisfies a denial constraint denc of the form ¬(p₁∧ . . . ∧pₙ) iff there exists 1≤j≤n such that γ(pⱼ)=0. A possible world γ satisfies a definite constraint defc of the form p₁∧ . . . ∧pₙ→p₀ iff γ(p₀)=1 or there exists 1≤j≤n such that γ(pⱼ)=0. Write γ|=denc and γ|=defc to denote satisfaction in these two cases.

Example 4 The possible worlds γ₅, γ₇, γ₁₃, γ₁₅ (See Table I, FIG. 13A) violate (e.g, do not satisfy) the denial constraint of Example 3, while the other possible worlds satisfy it. Also, γ₂, γ₃, γ₆, γ₇ all violate the definite constraint of Example 3, while the other possible worlds satisfy it.

Given a set IC of integrity constraints, say that a possible world γ satisfies IC, denoted γ|=IC, iff γ|=ic for all ic∈IC, otherwise γ does not satisfy IC and write γ|≠IC. Building upon our running example, the possible worlds that satisfy the integrity constraints IC of Example 3 are γ₀, γ₁, γ₄, γ₈, γ₉, γ₁₀, γ₁₁, γ₁₂, γ₁₄.

The next case deals with associating a probability that a possible world is the actual world. To do so, a possible world distribution is defined.

### Definition 7 (Possible World Distribution)

A possible world distribution w.r.t. a set IC of integrity constraints is a probability distribution ρ_{IC} over PW such that ρ_{IC}(γ)=0 for all possible worlds γ∈PW with γ|≠IC.

The last column of Table 2 shows a sample possible world distribution ρ_{IC} w.r.t. the set IC of integrity constraints of our running example. For instance, this possible world distribution assigns a 10% probability of being correct to each of γ₁, γ₄, γ₉, γ₁₄, a 15% probability of being correct to γ₁₀, a 20% probability of being correct to each of γ₀ and γ₈, and a 5% probability to γ₁.

Example 5 Let us consider proposition p₃ in FIG. 2. The situation is as follows:

| | | |
|---|---|---|
| Source | Testimony | Assessment |

| | | | |
|---|---|---|---|
| s₁ | 0 | (false) | 0.6 |
| s₃ | 1 | (true) | 0.3 |
| s₄ | 1 | (true) | 0.5 |

This causes a dilemma. Both sources that say p₁ is true have low credibility—s₃ is assessed as lying with 70% probability, while s₄ is assesses as lying with 50% probability. What should be inferred from this? It is clear that this situation can be resolved in many different ways.

To address this issue, combination functions are introduced, which return a confidence value about a proposition being true, on the basis of a witness and an assessment function.

Definition 8 (Combination Function) A combination function (CF) is a function cf that takes as input a proposition p, a witness function ω, and an assessment function α for ω, and returns a value in [0,1] as output.

Rather than committing to a specific combination function, a general definition is provided that allows different concrete instances that can accommodate different needs, depending on the application at hand. In the following, 10 concrete combination functions are proposed. A judge making a decision can either choose a default combination function within JUST or pick one of the 10 suggested by us or use some other combination function altogether. Of course, this library of 10 combination functions can be extended easily if future research suggests better ones.

Now, given a witness function ω, an assessment function α for ω, a set of integrity constraints IC, and having chosen a combination function cf, possible world distributions may be found by solving the set LC of linear constraints defined as follows:

$$( \begin{matrix}0 \leq {\sum }_{{γ}_{j} ∈ PW , {γ}_{j} \vert = IC , {γ}_{j} ( {p}_{i} ) = 1} {X}_{j} \leq cf ( {p}_{i} , ω , α ) , for {p}_{i} ∈ \\ 0 \leq {X}_{j} \leq 1 , for {γ}_{j} ∈ PW s . t . {γ}_{j} \vert = IC \\ {\sum }_{{γ}_{j} ∈ PW , {γ}_{j} \vert = IC} {X}_{j} = 1\end{matrix} .$$

In the set of linear constraints above, each variable Xⱼ stands for the (unknown) probability of a possible world γⱼ satisfying the integrity constraints. Also, use the value returned by the combination function for proposition pᵢ as an upper bound for the probability of pᵢ being true.

It easy to see that each solution of LC corresponds to a possible world distribution, and vice versa. In general, LC can have multiple solutions (e.g., possible world distributions) because independence between propositions is not assumed. These solutions can be found by using an off the shelf linear program solving tool such as CPLEX or Gurobi. Thus, a fixed possible world γ can have different probabilities w.r.t. different possible world distributions. One way to get a single probability for γ is to define it as its average probability across all possible world distributions. Then, a set of top-k possible worlds is a set of k possible worlds with highest average probability.

Qualitative Assessments. Judges or juries may be uncomfortable assigning probabilities to witness statements. Suppose a judge/jury prefers to assign a “low”, “medium”, “high” rating to the credibility of a witness statement. These can be easily converted to the intervals [0; ⅓]; [⅓; ⅔]; [⅔; 1], respectively. This can be easily handled via a small modification to the JUST framework: (i) the definition of combination function would be replaced by a function cf′ that behaves just like cf except that cf′(pᵢ; ω;α) would return a probability interval rather than a probability. (ii) The first constraint shown above would be replaced by the constraint:

$${\sum }_{γ j ∈ PW ; γ j = IC ; γ j ( pi ) = 1} Xj ∈ {cf}^{′} ( pi ; ω ; α ) ; for pi ∈ P :$$

### Combination Functions

When multiple witnesses disagree about a proposition and the assessment function for the witnesses varies, a judge can choose a combination function (CF) to combine the values into a single number representing the probability of a proposition being true. Below, two classes of CFs are introduce.

Standard CFs. The simplest CFs use aggregate operators Φ (consider the 5 aggregates min, max, avg, median, mode in our experiments) that take a multiset of real numbers in [0,1] and return a number in the [0,1] interval. Specifically, the basic idea to determine the probability of a proposition p is to combine all statements made about p as follows: take the value α(s; p) for each statement (made by some source s) claiming that p is true, take the value 1−α(s′; p) for each statement (made by some source s′) claiming that p is false, and then apply an aggregate operator Φ over all such collected values.

### Definition 9 (Standard CF)

Given an aggregate operator Φ and a proposition p, define the combination function:

$${cf}_{Φ} ( p , ω , α ) = Φ ( \{ α ( s , p ) \vert ω ( s , p ) = 1 \} ⋃ \{ 1 - α ( s , p ) \vert ω ( s , p ) = 0 \} ) .$$

Example 6. Consider proposition p₃ of the running example. All statements made about p₃ (along with their assessmeωnt function values) are reported in Example 5. Thus, source s₃ (resp., s₄) is claiming p₃ is true and the assessment function value for such a statement is 0.3 (resp., 0.5), while source s₁ is claiming p₃ is false and the assessment function value for such a statement is 0.6. Using e.g. the average aggregate operator, which results in cf_{avg}(p3; ω; α)=avg({0.3; 0.5; (1−0.6)})=0.4.

Trust-Based CFs. The basic idea of this family of CFs is to assign a score to each source, measuring her/his “reliability”, and then compute each propositions' probability on the basis of such scores. Trust-based CFs determine the probability of a proposition p by looking also at ω(sᵢ,p′) and ω(sᵢ,p′) values with p′≠p, e.g., by looking also at witness statements for propositions other than p. Define the trust of source s as the average of the assessment function values for s's statements. However, other definitions of trust can be easily substituted here (e.g., median of the assessment function values for s's statements). The probability of a proposition p is then computed by applying an aggregate operator to the trust values of the sources who made statements about p.

### Definition 10 (Trust-Based CF)

For each source s its trust score is defined as

T(s)=avg({ω(s,p)|ω(s,p) is defined}).

Then, given an aggregate operator Φ and a proposition p, the combination function is defined as:

$${cf}_{Φ}^{trust} ( p , ω , α ) = Φ ( \{ T ( s ) \vert ω ( s , p ) = 1 \} ⋃ \{ 1 - T ( s ) \vert ω ( s , p ) = 0 \} ) .$$

Example 7. Consider again proposition p₃ of the running example. The sources who made statements about p₃ are s₁, s₃, and s₄, whose trust scores are as follows:

T(sᵢ)=avg([0.2,0.8,0.6])=0.53,

T(s₃)=avg([0.6,0.3])=0.45,

T(s₄)=avg([0.5,0.7])=0.6.

Using e.g., the max aggregate operator, which results in

cfₘₐₓ^{trust}(p₃,ω,α)=max([(1−0.53),0.45,0.6])=0.6.

### Just Algorithms

In this section, two approximation approaches are used to compute most likely possible worlds. The explicit approach (JUST^{exp}) makes no independence assumptions whatsoever and computes the average probability of each possible world over a sample of solutions of LC and then returns a top-k set of most likely ones (w.r.t. the average probability). The implicit approach (JUST^{imp}), assumes that only propositions appearing in no integrity constraints are independent, reducing the computational effort.

More specifically, JUST^{exp} (See Algorithm 1) works as follows. First, a set S of solutions of LC (e.g., probability distributions over possible worlds) is randomly sampled (line 1). For this, the well-known Hit-and-Run walk may be used (See, R. L. Smith, “Efficient monte carlo procedures for generating points uniformly distributed over bounded regions,” Operations Research, vol. 32, no. 6, pp. 1296-1308, 1984 and L. Lov'asz and S. S. Vempala, “Hit-and-run from a corner,” SIAM Journal on Computing, vol. 35, no. 4, pp. 985-1005, 2006. A number of other algorithms for this purpose are also usable for such sampling. Then, for each possible world γ, its expected probability EP(γ) (w.r.t. S) is computed (lines 2-4). Finally, a set of top-k (w.r.t. EP) possible worlds is returned (lines 5-6).

Before resenting JUST^{imp}, additional notation is introduced next. Possible worlds defined w.r.t. subsets [symbol] ′ of [symbol] , e.g., functions of the form γ′: [symbol] ′→{0,1} need to be considered. For notational convenience, such a function γ′ is represented also as the set {pᵢ|pᵢ∈ [symbol] ′ and γ′(pᵢ)=1}∪{p̅ᵢ̅|pᵢ∈ [symbol] ′ and γ′(pᵢ)=0}. PW[ [symbol] ′](resp., LC[ [symbol] ′]) is used to denote the set of possible worlds (resp., linear constraints) w.r.t. only the propositions in [symbol] ′. Under the independence assumption, the probability P(γ′) of a possible world γ′ in PW[ [symbol] ′] is defined to be:

$$( {\prod }_{p ∈ {𝒫}^{′} , {γ}^{′} ( p ) = 1} cf ( p , ω , α ) ) \cdot ( {\prod }_{p ∈ {𝒫}^{′} , {γ}^{′} ( p ) = 0} ( 1 - cf ( p , ω , α ) ) )$$

When γ′=Ø, P(γ′) is defined to be 0. For a set IC of integrity constraints, [symbol] _{IC} is the set of propositions in [symbol] that appear in IC, while [symbol] _̅{̅I̅C̅}̅= [symbol] \ [symbol] _{IC}.

### Algorithm 1 JUST^{esp}

```
Input: A witness function ω,
  an assessment function α for ω,
  a set IC of integrity constraints,
  a combination function cf, and
  positive integers k ≤ [symbol]  , s.
Output: A set of top-k possible worlds.
  1: Randomly sample a set S of solutions of LC with |S| = s.
  2: for each γ ∈ PW do
  $3 : EP ( γ ) = \frac{{\sum }_{ρ ∈ S} ρ ( γ )}{\vert S \vert}$
  4: end for
  5: Let Top be top-k (w.r.t. EP) possible worlds.
  6: return Top.
```

```
Input: A witness function ω,
  an assessment function α for ω,
  a set IC of integri $3 : EP ( γ ) = \frac{{\sum }_{ρ ∈ S} ρ ( γ )}{\vert S \vert}$ ty constraints,
  a combination function cf, and
  positive integers k ≤ [symbol]  , k′ ≤ [symbol]  , s
Output: A set of top-k possible worlds.
  1: Randomly sample a set S of solutions of LC [symbol]   with |S| = s.
  2: for each γ ∈ PW[P_{IC}] do
  $3 : EP ( γ ) = \frac{{\sum }_{ρ ∈ S} ρ ( γ )}{\vert S \vert}$
  4: end for
  5: Compute a set Top′ of top-k′ possible worlds from PW [symbol]
  under the independence assumption.
  6: for each γ ∈ PW [symbol]   and γ′ ∈ Top′ do
  7:  γ* = γ ∪ γ′.
  8:  EP(γ*) = EP(γ) × P(γ′).
  9: end for
  10: Let Top be top-k (w.r.t. EP) possible worlds from PW.
  11: return Top.
```

JUST^{imp} (See, Algorithm 2) works as follows. First, a set S of solutions of LC[ [symbol] _{IC}] is randomly sampled (line 1). Then, for each possible world γ in PW[ [symbol] _{IC}], its expected probability EP(γ) (w.r.t. S) is computed (lines 2-4). Then, a set of top-k′ possible worlds from PW[ [symbol] _̅{̅I̅C̅}̅] is computed under the independence assumption (line 5)—will be discussed in further detail below. Then, for each pair of possible worlds γ in PW[ [symbol] _{IC}] and γ′ from the previous step, γ and γ′ are combined into a possible world γ* with probability EP(γ)×P(γ′) (lines 6-9). Finally, a set of top-k possible worlds from those computed at the previous step is returned (lines 10-11).

We still need to show how to compute a set of top-k′ possible worlds under the independence assumption (line 5 of JUST^{imp}). To address this problem in the following, by providing a dynamic programming algorithm, called JUST^{ind} (See Algorithm 3), whose worst-case time complexity is O(m·k′), where m is the number of propositions in [symbol] _̅{̅I̅C̅}̅, and thus it runs in pseudo-polynomial time.

One key idea of Algorithm 3 is to build possible worlds bottom-up. It starts by considering only one proposition and then iteratively considers the remaining ones, one at a time.

The details of JUST^{ind.} is presented next. On line 1, m is set to the number of propositions. On lines 2-9, three arrays Top, Lₜ, and L_{f} are introduced, each with k′ entries initialized to the empty set. The array Top stores the most likely possible world for the propositions currently considered, while Lₜ, and L_{f} are auxiliary arrays whose role will be explained shortly.

Line 10 introduces the integer n, which is initialized to 1 and then updated on line 17, whose meaning is as follows. The value of n after being updated on line 17 is the number of most likely possible worlds to be computed: n is strictly lower than k′ when i propositions are being considered and their number of possible worlds is 2ⁱ≤k′—indeed, in such a case, n=2ⁱ; when i becomes high enough, e.g., it is such that 2ⁱ≥k′, n becomes equal to k′.

The for loop on lines 11-21 performs m iterations. At any iteration i, the top-n most likely possible worlds are computed on lines 12-20 by considering only the first i propositions (an arbitrary order over the propositions can be used). Specifically, on lines 12-15, each possible world in Top is augmented with proposition pᵢ being true (resp., false) and the resulting world is stored in Lₜ (resp., L_{f})—see line 13 (resp., line 14). Next, Lₜ and L_{f} are merged into an array L sorted by descending P value (line 16). Then, the top-n possible worlds in L are copied into Top (lines 18-20).

Finally, after m iterations of the for loop on lines 11-21, the array Top, containing the top-k′ most likely possible worlds (sorted by descending probability) w.r.t. all propositions in [symbol] _̅{̅I̅C̅}̅, is returned (line 22).

Algorithm 3 JUST^{ind}

Input: cf(pᵢ, ω, α) for each pᵢ ϵ [symbol] ,
a positive integer k′ s.t. k′ ≤ [symbol] .
Output: A set of top-k′ possible worlds.
1: m = [symbol] .
2: Top[1..k′].
3: Lₜ[1..k′].
4: L_{f}[1..k′].
5: for i = 1 to k′ do
6: Top[i] = Ø.
7: Lₜ[i] = Ø.
8: L_{f}[i] = Ø.
9: end for
10: n = 1.
11: for i = 1 to m do
12: for j = 1 to n do
13: Lₜ[j] = Top[j] ∪ {pᵢ}.
14: L_{f}[j] = Top[j] ∪ {p̅ᵢ̅}.
15: end for
16: Merge Lₜ[1..n] and L_{f}[1..n] into L[1..2n] sorted by descending P.
17: n = min{2 × n, k′}.
18: for j = 1 to n do
19: Top[j] = L[j].
20: end for
21: end for
22: return Top.

The following two theorems state the correctness and the worst-case time complexity of Algorithm 3.

```
Theorem 1 Algorithm 3 computes top-k′ possible worlds under the independence
assumption.
Proof. In the following, use the set-oriented representation of possible worlds introduced
before. Let [symbol]     = {p₁, ... , pₘ}. For 0 ≤ i ≤ m, use the following notation:
  • [symbol]     is the set of the first i propositions in [symbol]     (here an arbitrary order of the
propositions is assumed)—notice that [symbol]     = Ø;
  • Γᵢ is the set of all possible worlds w.r.t. [symbol]    , that is, when only the propositions
in [symbol]     are considered—define Γ₀ = {Ø};
  • Tᵢ^{k′} is a set of top-k′ possible worlds w.r.t. Γᵢ—notice that T₀^{k′} = {Ø} and Tₘ^{k′} is
a set of top-k′ possible worlds for the algorithm's input.
Let Top − k′ be a function that takes as input a set of possible worlds and returns a set of
top-k′ ones.
For 1 ≤ i ≤ m, define
  Lᵢ = {x ∪ {pᵢ}|x ϵ Tᵢ₋₁^{k′}} ∪ {x ∪ {p̅i̅}|x ϵ Tᵢ₋₁^{k′}}
```

Prove that the following optimal substructure property holds for each 1≤i≤m:

$${T}_{i}^{k ′} = Top - {k}^{′} ( {L}_{i} ) . \qquad ( 1 )$$

Let Sᵢ be the result of Top−k′(Lᵢ). What must be shown is that Sᵢ=Tᵢ^{k}′. When Tᵢ₋₁^{k}′=Γᵢ₋₁, the claim is straightforward, since Lᵢ=Γᵢ in such a case. Below consider the case where Tᵢ₋₁^{k}′ÖΓᵢ₋₁. To prove Equation 1, it is shown that P(γ)≥P(γ′) for every γ∈Sᵢ and γ′∈Γᵢ\Lᵢ (notice that here it suffices to consider Γᵢ\Lᵢ rather than Γᵢ\Sᵢ because Sᵢ contains top-k′ elements of Lᵢ). It is proven it by showing that P(γ)≥P(γ′), where γ (resp., γ′) is a possible worlds in Sᵢ (resp., Γᵢ\Lᵢ) with minimum (resp., maximum) P-clearly, among the possible worlds in Sᵢ (resp., Γᵢ\Lᵢ).

Let γ″ (resp., γ′″) be a possible world in Tᵢ₋₁^{k}k′ (resp., Γᵢ₋₁\Tᵢ₋₁^{k}′) with minimum (resp., maximum) P. Clearly, P(γ″)≥P(γ′″), since Tᵢ₋₁^{k}′ is a top-k′ set of Γᵢ₋₁. Let pᵢ^{max}=max{P(pᵢ), P(p̅ᵢ̅)}. Now notice that P(γ)≥P(γ″)×pᵢ^{max} and P(γ′)=P(γ′″)×pᵢ^{max}. Then, it follows that P(γ)≥P(γ′).

It can be easily verified that JUST^{ind} is an implementation of Equation (1) above which eventually returns Tₘ^{k}′.

### Theorem 2 the Worst-Case Time Complexity of Algorithm 3 is O(m·k′).

Proof Notice that n≤k′ at any time, as n is initially equal to 1 (line 10) and then it is updated only on line 17 to min{2×n, k′}.

Line 1 takes Θ(1) time. Lines 2-9 take Θ(k′) time. Line 10 takes Θ(1) time.

Let us now analyze the cost of a single iteration of the for loop on lines 11-21, namely lines 12-20.

Lines 12-15 take Θ(n) time, which is O(k′), since n≤k′—here the addition of the elements pᵢ and p̅ᵢ̅ takes constant time.

The time complexity of line 16 is discussed next. Notice that Top is always sorted by descending score: initially all its elements are the empty set (see line 6); then, Top is updated only on lines 18-20 where the first n elements of L are copied into Top, and since L is sorted by descending P (see line 16), so is Top. Notice that the elements of Top after the n-th one, if any, are the empty set, and thus their P value is 0 by definition. As a consequence, Lₜ (resp., L_{f}) is always sorted by descending P. Initially, all its elements are the empty set—see line 7 (resp., line 8). Then, Lₜ (resp., L_{f}) is updated only in the for loop on lines 12-15, where the first n elements of Top are copied into Lₜ (resp., L_{f}) with the addition of the same element pᵢ(resp., p̅ᵢ̅). Since Top is sorted by descending P and the addition of the same element pᵢ(resp., p̅ᵢ̅) to the first n elements of Top does not change their order, Lₜ (resp., L_{f}) remains sorted by descending P. Notice that the elements of Lₜ (resp., L_{f}) after the n-th one, if any, are the empty set, and thus their P value is 0 by definition. Since Lₜ[1 . . . n] and L_{f}[1 . . . n] are sorted by descending P, merging them into L [1 . . . 2n] sorted by descending P takes Θ(n) time, which is O(k′), since n≤k′.

Line 17 takes linear time in the size of k′. Lines 18-20 take Θ(n) time, which is O(k′), since n≤k′.

Thus, a single iteration of the for loop on lines 11-21 takes O(k′) time. Since the for loop performs Θ(m) iterations, lines 11-21 takes O(m·k′) time.

Line 22 takes Θ(1) time.

It follows from the analysis above that the worst-case time complexity of algorithm 3 is O(m·k′).

### Experimental Evaluation

In this section, the experiments conducted with 24 datasets (19 TV legal cases and 5 real-world court cases) to assess the efficacy of our framework are reported.

JUST^{exp}, JUST^{imp}, JUST^{ind}, the CFs, and the integrity constraint checker were implemented using one or more computing languages, such as in Python. Experiments were run on a 3.10 GHz Intel Core i9-9960X CPU with 131 GB of RAM, running Ubuntu 18.04.5. The number of samples (e.g., the s input in alg:just-exp,alg:just-imp) was set to 20. For JUST^{imp}, the number k′ of possible worlds considered under the independence assumption was k′=|PW[ [symbol] _{IC}]|, that is, the same number of possible worlds induced by propositions appearing in the integrity constraints. Min, max, avg, mode, and median were used in the standard CFs as per Definition 9, and also considered their trust-based counterparts (see, Definition 10). In all, 10 CFs were considered.

Datasets. 5 real-word trial cases were considered: Casey Anthony (CA) [https://en.wikipedia.org/wiki/Death_of_Caylee_Anthony](30.5 hours of video), Ashley McArthur (AMA) [https://heavy.com/news/ashley-mcarthur-today](14 hours of video), Jacob Cayer (JC)[https://www.greenbaypressgazette.com/story/news/2020/08/13/jacob-cayer-trial-jury-decide-insanity-after-murder-verdict/3361870001/](22 hours of video), Nathaniel Rowland (NR) [https://apnews.com/article/south-carolina-uber-nathaniel-rowland-samantha-josephson-28626a2e564963fb1fld8a452b016207](16 hours of video), Joshua Aide (JA) [https://fox11online.com/news/crime/man-who-killed-ex-girlfriends-father-shot-2-others-sentenced-to-life](17.5 hours of video). Nineteen additional cases were considered that were taken from the US TV show “Judge Judy” (JJ), which are 10 minutes long on average.

The sources, propositions and witness functions were manually annotated. Because no judges were convinced to spend the time necessary to provide the assessment function, an online “deception detection algorithm” was used [Z. Wu, B. Singh, L. S. Davis, and V. S. Subrahmanian, “Deception detection in videos,” in Proc. AAAI, 2018, pp. 1695-1702] that was trained on a real world courtroom dataset [V. P'erez-Rosas, M. Abouelenien, R. Mihalcea, and M. Burzo, “Deception detection using real-life trial data,” in Proc. ICMI, 2015, p. 59-66]. Of course, this is just a proxy for a judge's assessments and it is not suggested that deception detection algorithms be used for assessment and it is not suggested that deception detection algorithms be used for assessment.

For the CA, AMA, JC, NR, and JA datasets 7, 3, 7, 5, 6 integrity constraints were defined, respectively. For example, these were the natural number of ICs for the propositions in the case. The number of ICs for the JJ dataset ranged from 0 to 3 as these cases were short (10 minutes compared to, e.g., 30.5 hours for CA) and had a smaller number of propositions.

Prediction Performance. For each dataset, its video(s) were manually watched and captured the real ground truth (which is a possible world) based on what the judge in the case decided to be true vs. false. In the following, two metrics are defined to measure prediction performance, denoted PP[i] and PP*[i], whose goal is to assess (in different ways) the quality of the first i possible worlds, for 1≤i≤k.

A definition of PP[i] follows. For a given dataset, let γ* be the ground truth possible world and γ₁, . . . , γₙ be the possible worlds that were computed and sorted by descending probability. For 1≤i≤n and for each proposition pⱼ∈ [symbol] , is defined F[i][j]=1 if there exists a possible world γₖ with k≤i s.t. γ*(pⱼ)=γₖ(pⱼ), that is, there is a possible world among the first i ones that agrees with the ground truth on pⱼ's truth value; otherwise, F[i][j]=0. Then, for each 1≤i≤n, the prediction performance of the top-i possible worlds, denoted PP[i], is defined as the average of F[i][j] across all propositions pⱼ's. The second metric proposed is more demanding and is based on the following idea. In an “ideal” set of top-k possible worlds, the first one (e.g., the most likely one) is the ground truth, then it results with all possible worlds that are the same as the ground truth except for the truth value of one proposition, then it results with all possible worlds that are the same as the ground truth except for the truth value of two propositions, and so on, and so forth.

In general, if m is the number of propositions, then the number of possible words that differ from the ground truth by j proposition truth values is (ⱼ^{m}), with 0≤j≤m. Thus, there is (₀^{m})=1 possible world differing from the ground truth by 0 propositions (this is the ground truth itself), there are (₁^{m})=m possible worlds differing from the ground truth by 1 proposition, and so on, so forth. In an ideal set of top-k possible worlds, the i-th possible world (1≤i≤k) is the same as the ground truth except for the truth value of xᵢ propositions, where 0≤xᵢ≤m is the smallest integer s.t. i≤Σₕ₌₀^{xi}ω(ₕ^{m}). Equivalently, the i-th possible world agrees with the ground truth function on m−xᵢ proposition truth values, and used nᵢ to denote the value m−xᵢ. Thus, nᵢ must be read as the number of propositions the ground truth and the n ideal result.

Now let γ₁, . . . , γₖ be the possible worlds that were computed and are sorted by descending probability. We want to measure how much this (sorted) set differs from the ideal result discussed above by assigning a score to each possible world γᵢ measuring how much γᵢ differs from a possible world in the same position in an ideal result. We then compute the average score across all possible worlds. For a possible world γᵢ, let nᵢ be the number of propositions on which γⱼ and the ground truth agree. Then, we define score(γj)=min{1, n_{γ}_{ᵢ}/nᵢ}, and for each 1≤i≤k, we define PP*[i]=avg{score(γₕ)|1≤h≤i}.

JUST^{exp} vs. JUST^{imp}. While JUST^{imp} terminated in all 24 cases, JUST^{exp} terminated within half an hour only on the JA, JJ6, JJ11, JJ14, JJ16, and JJ19 datasets. Since results did not vary substantially across different CF aggregate operators, in the following a representative case is discussed, which is cf_{avg}—where standard vs. trust-based CFs is discussed later on. Running times (in seconds) of JUST^{exp} and JUST^{imp} are reported in Table II of FIG. 13B. It is seen that JUST^{imp} took less than 1 second in all cases but two, one of which is the CA dataset, which has a much higher number of possible worlds, hence higher run time. JUST^{imp} is always 1-3 orders of magnitude faster than JUST^{exp}.

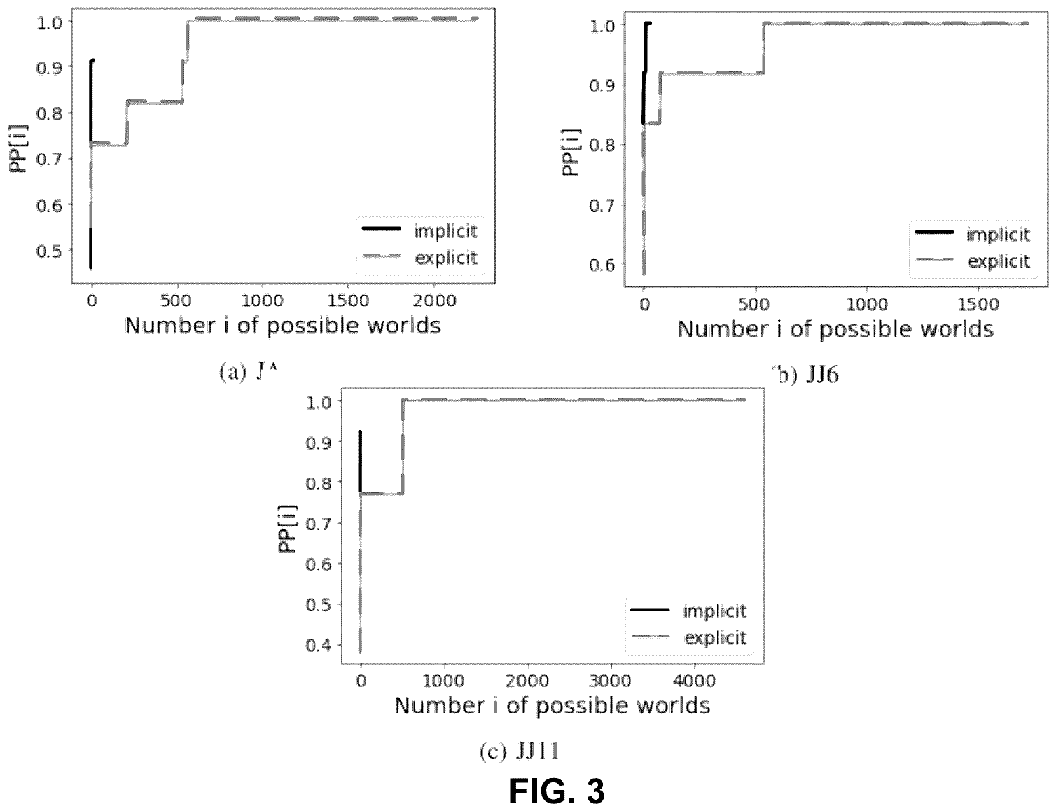

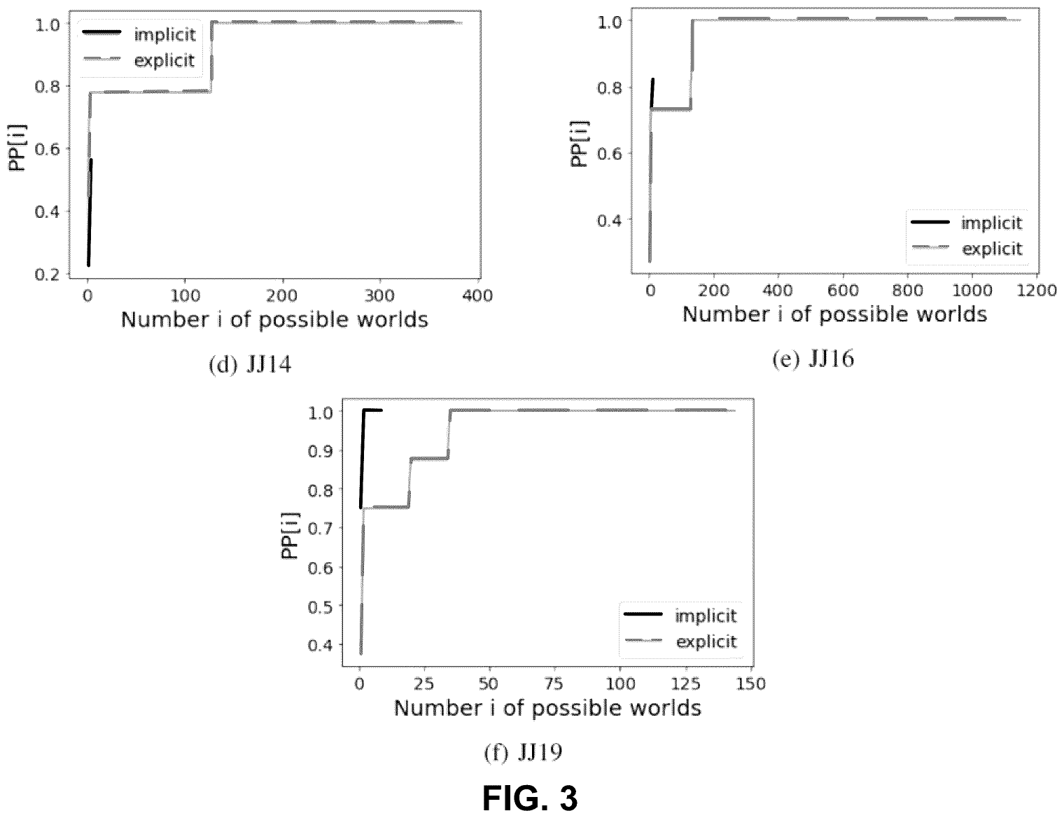

FIGS. 3A-3F show the prediction performance of the two approaches as the number of considered possible worlds increases. JUST® XP always reaches a PP value of 1, even though this might require considering a high number of possible worlds (up to 524 and 297 on average across the 6 datasets). JUST^{imp} does not always reach a PP value of 1, but still gets to high PP values with few possible worlds: besides JJ14 where the highest PP[i] is 0.55 but with only 3 possible worlds, on the remaining 5 cases JUST^{imp} reaches the PP values 0.81, 0.91, 0.91, 1, 1 after considering only 7, 5, 6, 5, 13 possible worlds, respectively.

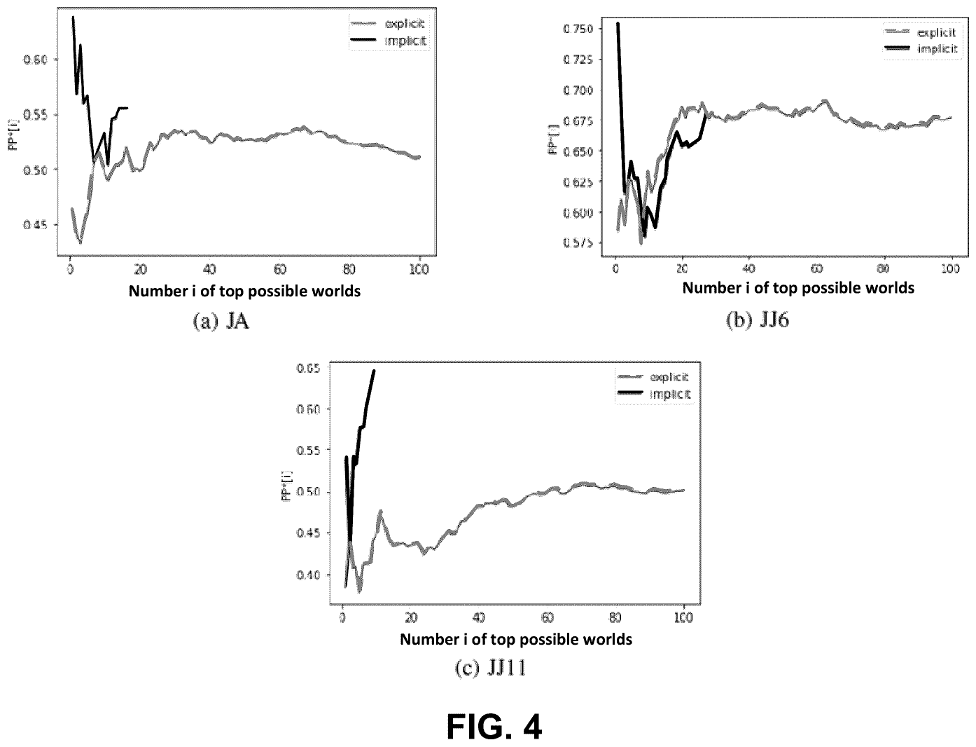

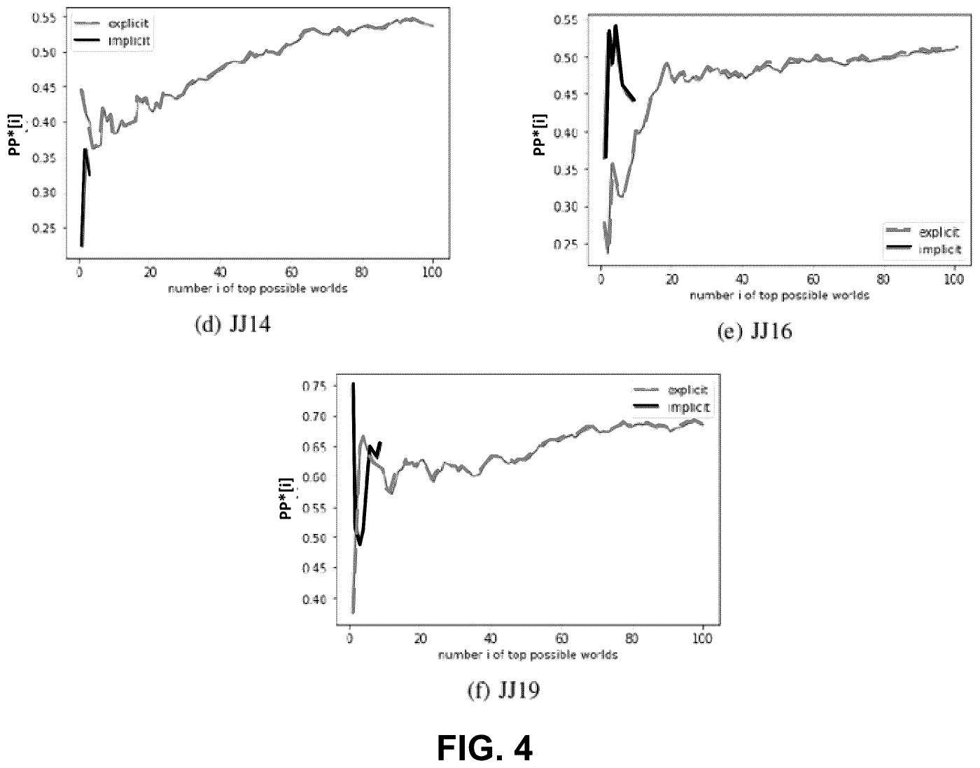

FIGS. 4A-4F show the prediction performance PP* of the two approaches as the number of considered possible worlds increases. Overall, with few possible worlds JUST^{imp} reaches PP* values similar to those reached by JUST^{exp} with more possible worlds-indeed, for the JA and JJ11 datasets, JUST^{imp} reaches higher values, while JUST^{imp} values are lower for the JJ14 dataset. Notice that PP* values are lower than those of the PP metric: as already mentioned before, PP* is a somewhat demanding metric (e.g., it can give a low value to a result where the most likely possible world is the ground truth, but the remaining possible worlds are not the expected ones in their respective positions).

Also, recall that JUST^{imp} was able to provide results on the remaining 18 datasets too (requiring little time) while the JUST^{exp} did not. It was concluded that JUST^{imp} achieves a good trade-off between quality of the results and running time.

Standard vs. trust-based CFs. Standard CFs were compared against their trust-based counterpart using (as it was able to terminate over all datasets). The running times of a CF and its trust-based counterpart were very close in all cases. Thus, the choice of CF does not significantly affect run time. As such, the quality of the results is the focus.

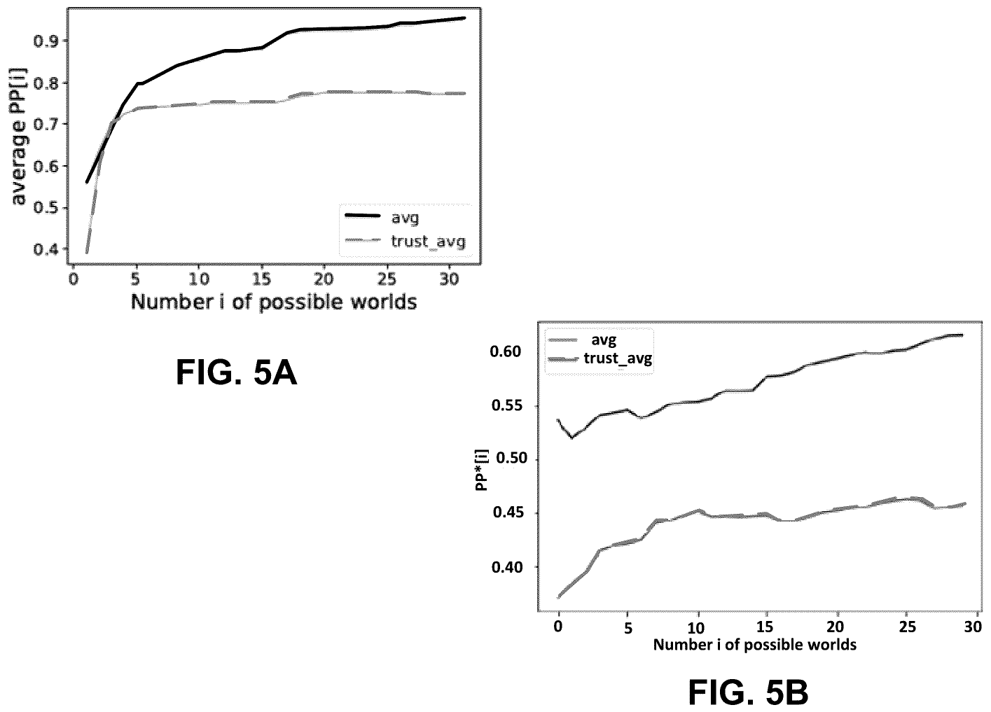

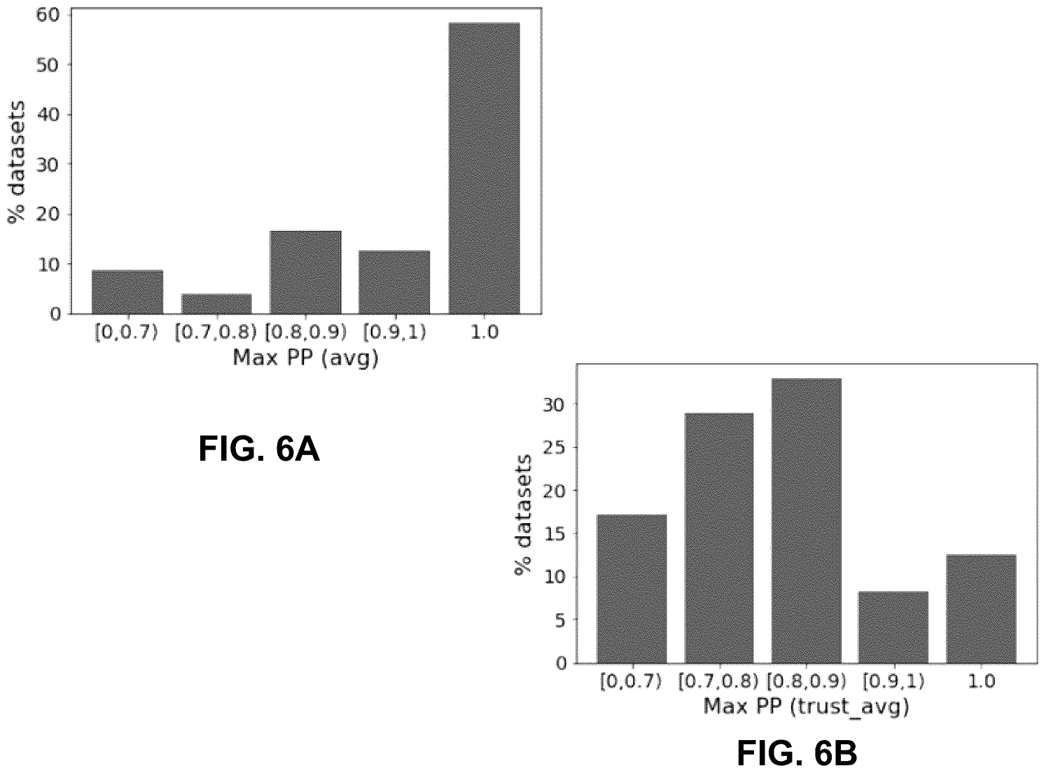

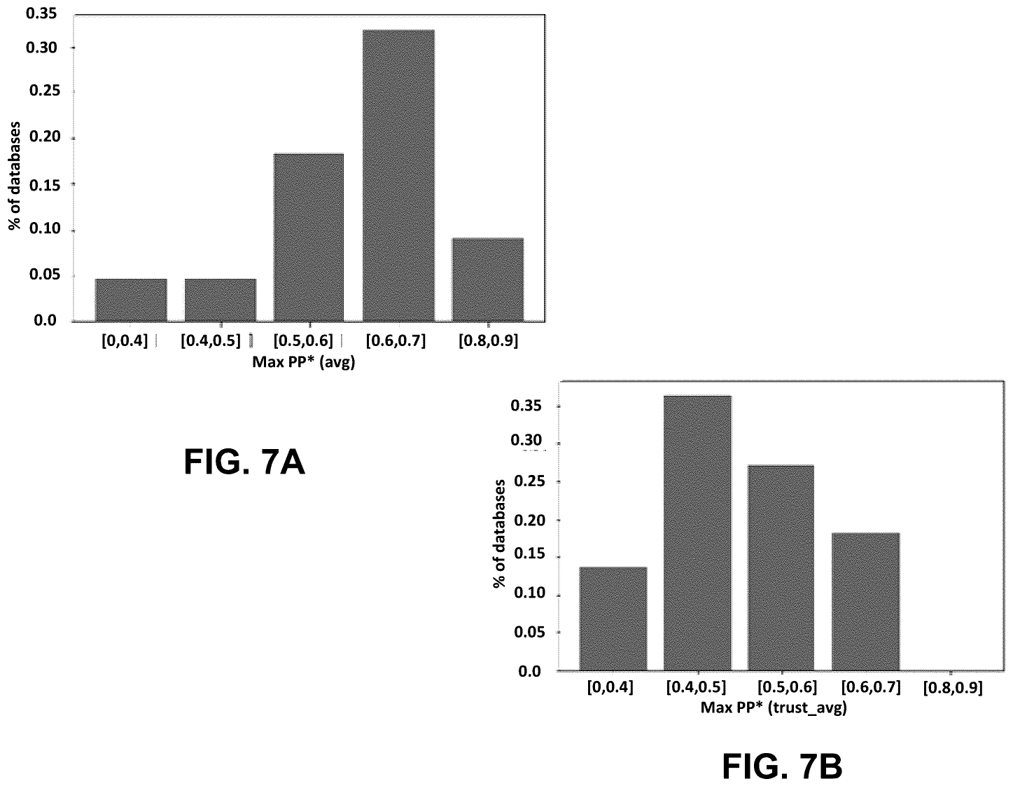

FIGS. 5A and 5B shows the average prediction performance (across all datasets) for both PP (FIG. 5A) and PP* (FIG. 5B) as the number of considered possible worlds increases, comparing cf_{avg} against cf^{trust}_{avg}—the other aggregate operators showed an almost identical trend, so the choice of the specific aggregate does not affect significantly the results and report a representative case only. The standard CF achieves higher prediction performance values than the trust-based counterpart for both PP and PP*. Importantly, the results in FIGS. 5A and 5B show that good prediction performance values can be obtained with only 30 possible worlds. FIGS. 6A, 6B, 7A, and 7B show the distributions of the maximum PP and PP* values, respectively, reached by JUST^{imp} over all datasets, for cf_{avg} and cf^{trust}_{avg}, confirming a better behavior of standard combination functions.

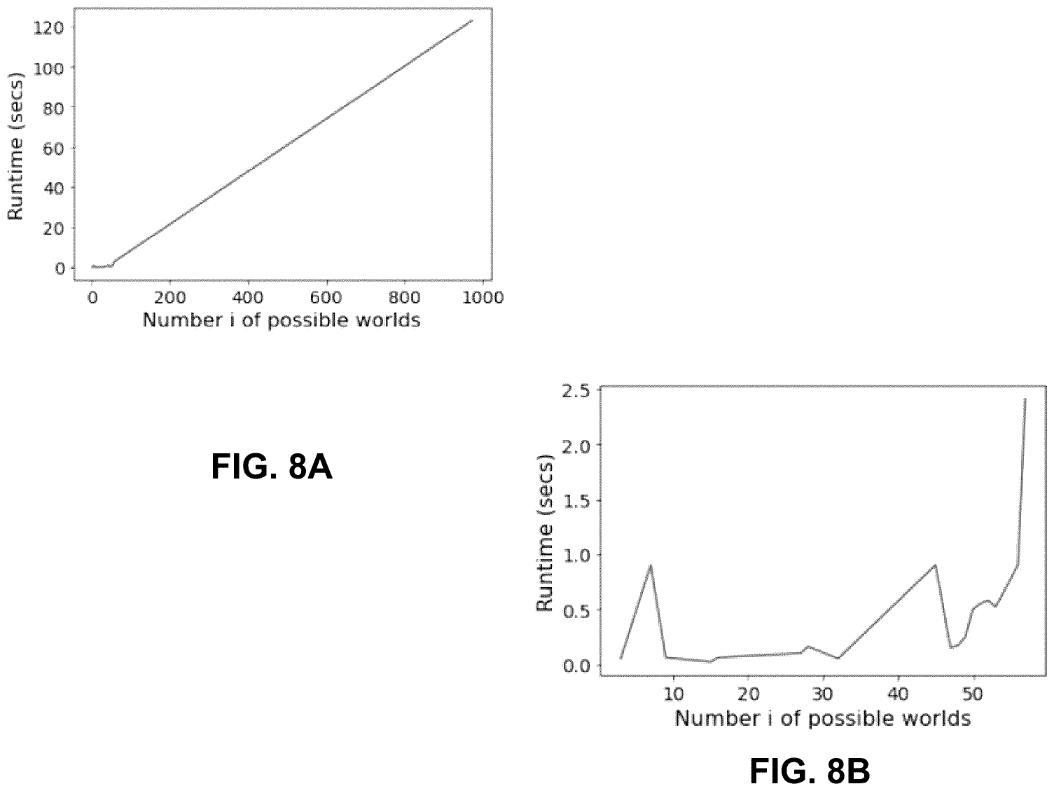

FIGS. 8A and 8B show the average run time of JUST^{imp} across all datasets and CFs as the number of possible world increases, w/ and w/o the CA dataset (recall that the run time for this dataset is higher because of the much higher number of possible worlds). It is seen that JUST^{imp} scales well even when considering the CA dataset, with very low running time when the latter is not considered.

To summarize, our evaluation shows that JUST^{imp} provides results of very high quality, has low running times, standard CFs are better than trust-based ones, with no significant difference across the different aggregates.

### RELATED WORK

There is much work on legal systems using logical methods [R. A. Kowalski, “Legislation as logic programs,” in Informatics and the Foundations of Legal Reasoning, 1995, pp. 325-356], [R. Kowalski and A. Datoo, “Logical english meets legal english for swaps and derivatives,” Artificial Intelligence and Law, August 2021], and [J. van Benthem, D. Fern'andez-Duque, and E. Pacuit, “Evidence logic: A new look at neighborhood structures,” in Proc. Advances in Modal Logic, 2012, pp. 97-118] introduced evidence logic as a way to model epistemic agents faced with possibly contradictory evidence from different sources, where each agent has a collection of possible worlds, one of which the agent believes to be the actual world. [F. Liu and E. Lorini, “Reasoning about belief, evidence and trust in a multi-agent setting,” in Proc. PRIMA, vol. 10621, 2017, pp. 71-89] introduced a logic where an agent accumulates evidence in support of a given fact from other agents in the society and the body of evidence in support of that fact can become a reason to believe it. [U. J. Schild, “Criminal sentencing and intelligent decision support,”

Artificial Intelligence and Law, vol. 6, no. 2, pp. 151-202, 1998]proposed a case-based sentencing support system. [P. Leith, “The judge and the computer: How best ‘decision support’?” Artificial Intelligence and Law, vol. 6, no. 2, pp. 289-309, 1998] created an automated decision support system for probation officers. [A. Karamlou, K. Cyras, and F. Toni, “Deciding the winner of a debate using bipolar argumentation,” in Proc. AAMAS, 2019, pp. 2366-2368] developed an argumentation framework to reason about debate outcomes. [T. K. Wah and M. Muniandy, “Courtroom decision support system using case based reasoning,” Procedia—Social and Behavioral Sciences, vol. 129, pp. 489-495, 2014] designed a case-based decision support system allowing plaintiff and defendant to solve their legal case without involvement of an actual judge. [I. Mokanov, D. Shane, and B. Cerat, “Facts2law: Using deep learning to provide a legal qualification to a set of facts,” in Proc. ICAIL, 2019, p. 268-269] developed Facts2Law, a model for matching a set of facts to relevant legal sources.

Some of the work in the area deals with situations where witnesses remember the same events differently [R. Anderson, “The rashomon effect and communication,” Canadian Journal of Communication, vol. 41, no. 2, 2016.], [W. D. Roth and J. D. Mehta, “The rashomon effect: Combining positivist and interpretivist approaches in the analysis of contested events,” Sociological Methods & Research, vol. 31, no. 2, pp. 131-173, 2002]. [A. Josang and V. A. Bondi, “Legal reasoning with subjective logic,” Artificial Intelligence and Law, vol. 8, no. 4, pp. 289-315, 2000] develop a logic for dealing with uncertainties in courtroom settings. [L. van Leeuwen and B. Verheij, “A comparison of two hybrid methods for analyzing evidential reasoning,” Frontiers in Artificial Intelligence and Applications, vol. 322, no. Legal Knowledge and Information Systems, p. 53-62, 2019.] analyzes and compares Bayesian networks with embedded scenarios and formal analysis of argument validity. There is also much work on detecting deception in trials [T. Fornaciari and M. Poesio, “Automatic deception detection in italian court cases,” Artificial Intelligence and Law, vol. 21, no. 3, pp. 303-340, 2013], [V. P'erez-Rosas, M. Abouelenien, R. Mihalcea, and M. Burzo, “Deception detection using real-life trial data,” in Proc. ICMI, 2015, p. 59-66]. A few efforts try to predict court decisions [N. Bagherian-Marandi, M. Ravanshadnia, and M.-R. Akbarzadeh-T, “Two-layered fuzzy logic-based model for predicting court decisions in construction contract disputes,” Artificial Intelligence and Law, vol. 29, no. 4, pp. 453-484, 2021], [M. Medvedeva, M. Vols, and M. Wieling, “Using machine learning to predict decisions of the european court of human rights,” Artificial Intelligence and Law, vol. 28, no. 2, pp. 237-266, 2020], and [A. Deeks, “The judicial demand for explainable artificial intelligence,” Columbia Law Review, vol. 119, no. 7, pp. 1829-1850, 2019]. [127][G. Van Opdorp, R. Walker, J. Schrickx, C. Groendijk, and P. Van den Berg, “Networks at work: a connectionist approach to non-deductive legal reasoning,” in Proceedings of the 3rd International Conference on Artificial Intelligence and Law, 1991, pp. 278-287] provides a connectionist approach to resolving semantically indeterminate terms like “suitable employment” in a legal context-such an approach might complement JUST in encoding language via propositions. [D. E. Rose, A symbolic and connectionist approach to legal information retrieval. Psychology Press, 2013] combines connectionist and symbolic reasoning for legal information retrieval-such methods may be useful in automatically extracting semantic knowledge (e.g., propositions) from legal transcripts.

Our work builds upon ideas in possible world from probabilistic/possibilistic logic, inconsistency and uncertainty management, which are all scenarios where uncertainty about the real state of the world arises [L. D. Raedt, A. Kimmig, and H. Toivonen, “Problog: A probabilistic prolog and its application in link discovery,” in Proc. IJCAI, 2007, pp. 2462-2467], [R. T. Ng and V. S. Subrahmanian, “Probabilistic logic programming,” Information and Computation, vol. 101, no. 2, pp. 150-201, 1992], [D. Dubois and H. Prade, “Possibilistic logic—an overview,” in Computational Logic, ser. Handbook of the History of Logic, J. H. Siekmann, Ed., 2014, vol. 9, pp. 283-342], [J. Grant and A. Hunter, “Measuring inconsistency in knowledgebases,” Journal of Intelligent Information Systems, vol. 27, no. 2, pp. 159-184, 2006], [T. Lukasiewicz, “Probabilistic logic programming with conditional constraints,” ACM Transactions on Computational Logic, vol. 2, no. 3, pp. 289-339, 2001]. We are not aware of work on efficient algorithms to find the top-k most probable worlds in real-world situations, especially when there are integrity constraints and where some propositions are independent of others, while some dependencies still exist between other propositions.

### LIMITATIONS AND DISCUSSION

Changing centuries of potential bias cannot be done via one paper-so this paper represents a small start in this direction. Many questions remain about how JUST can be deployed. (Q1) Won't a biased judge just assign biased probabilities to witness statements? There are at least two approaches to address this. One is to set up a framework where the judge's assessments are part of the record. In this case, lawyers for the aggrieved party can appeal based on the judge's assessments—and additionally a judge's record of disbelieving statements made by minorities may now be validated by data. Another is to have the jury assign the probabilities and take say the median probability assigned by the jury. (Q2) Isn't it challenging to encode natural language statements in logic? We did not find this hard to do when we coded our data. If a court reporting company writes down the propositions (along with the sentences from which the propositions are derived), a judge or jury can modify the statements to suit their understanding. (Q3) What about inconsistencies between statements made by a witness? The integrity constraints proposed within JUST are present exactly for this purpose. Recognize that a given set of integrity constraints may not flag some inconsistencies. In this case the judge/jury can add more integrity constraints.

### CONCLUSION AND FUTURE WORK

The JUST framework is presented, within which witness statements and the confidence in them are used to calculate the most likely scenarios in judicial cases.

Note that JUST does not use machine learning: rather it computes the k most probable worlds based on the judge's assessment (or jury's assessment, or combination of judge's and jury's assessments) of the veracity of witness statements and the combination functions selected by the judge. This is an extremely challenging task because the set of all possible worlds is exponential in the number of propositions. Taming this complexity is a large advancement over the present methods (Step 3 of the JUST architecture shown in FIG. 1). Having evaluated JUST over several real-world court cases, it is shown that that it efficiently provides a space of possible scenarios of high quality.

JUST has the potential to reduce judicial bias but changing centuries of bias is challenging, so JUST is a first step in this direction. JUST uses a judge's own assessment to compute the top-k most probable worlds. The judge will thus be aware of the mathematically most likely scenarios consistent with her own assessments. At the very least, the judge will see possible worlds that conflict with her/his views, and their final decision will therefore be better informed. If the judge's assessments are part of the formal record of the case, a consistent bias exhibited by a judge is more likely to be uncovered by the data and potentially lead to successful appeals.

### ADDITIONAL EXPERIMENTAL RESULTS

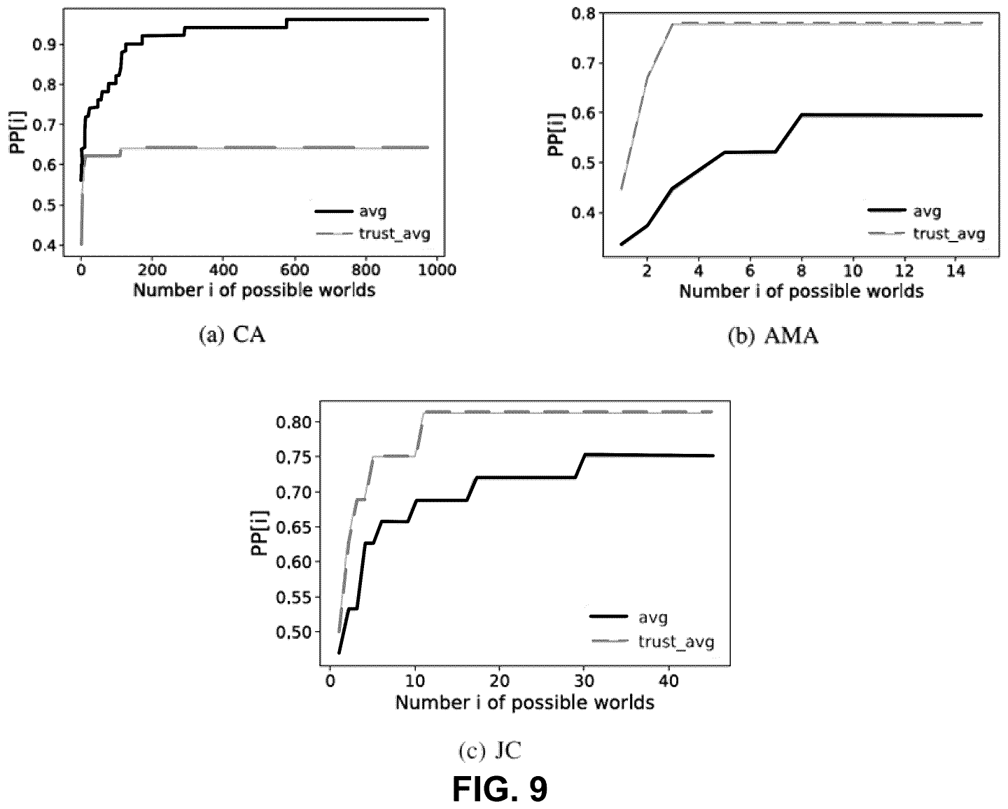

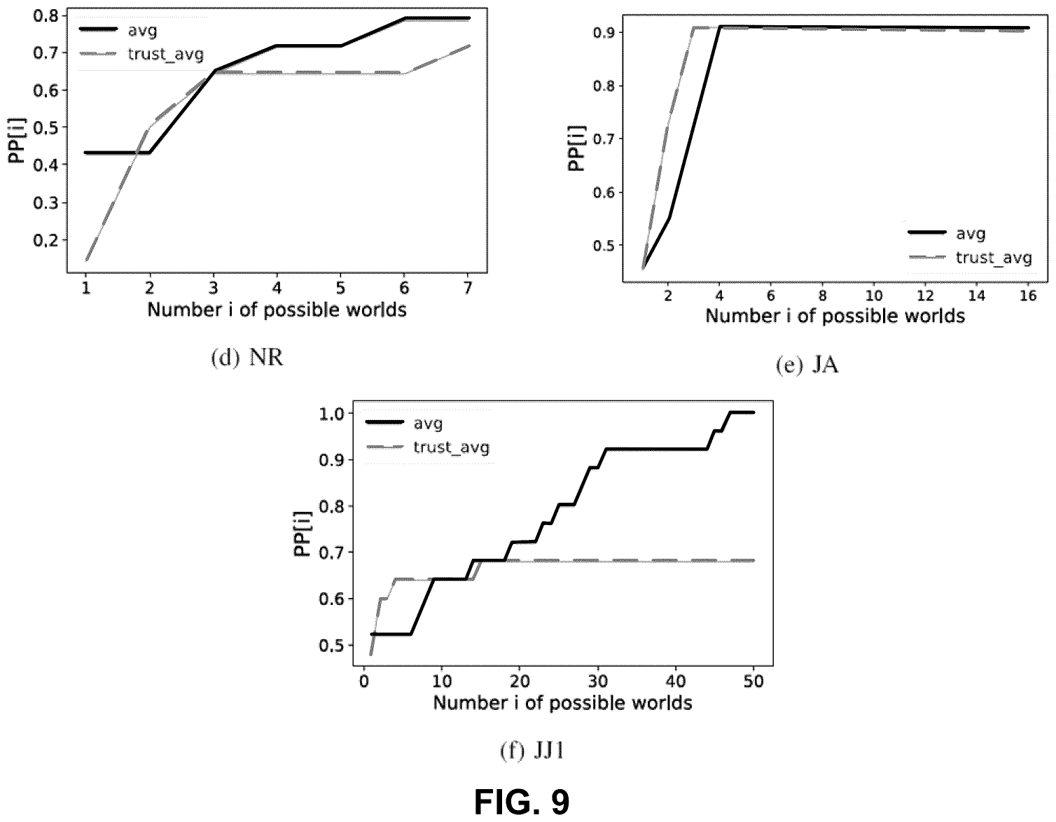

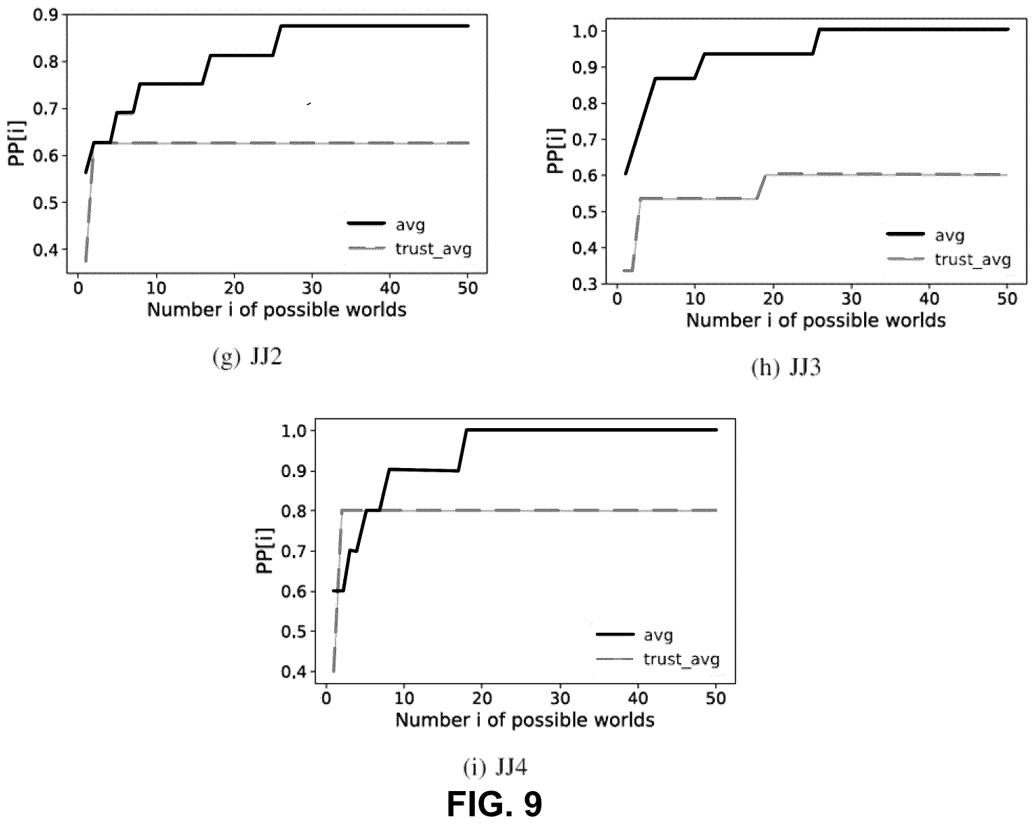

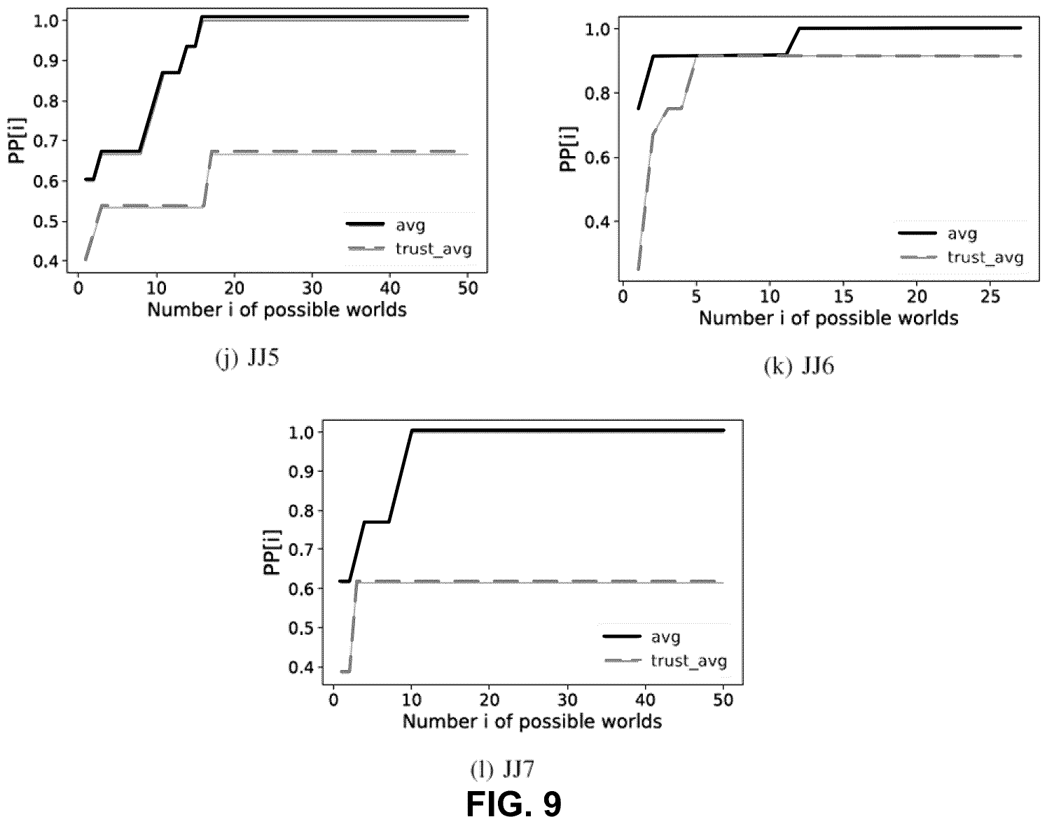

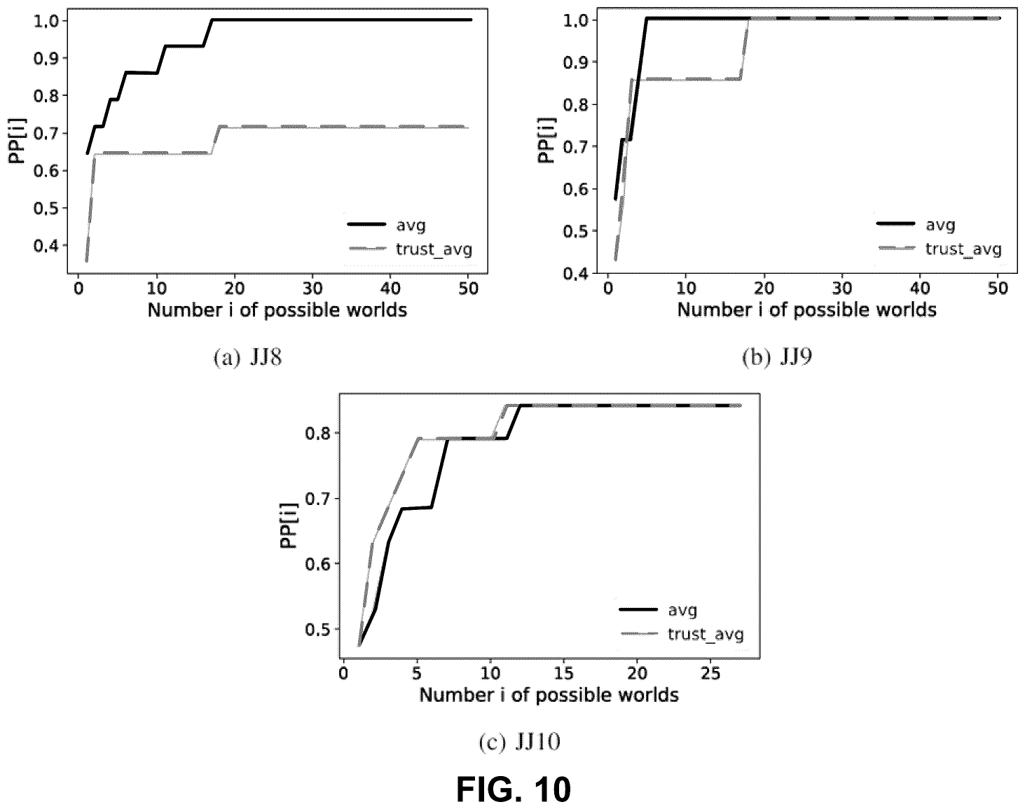

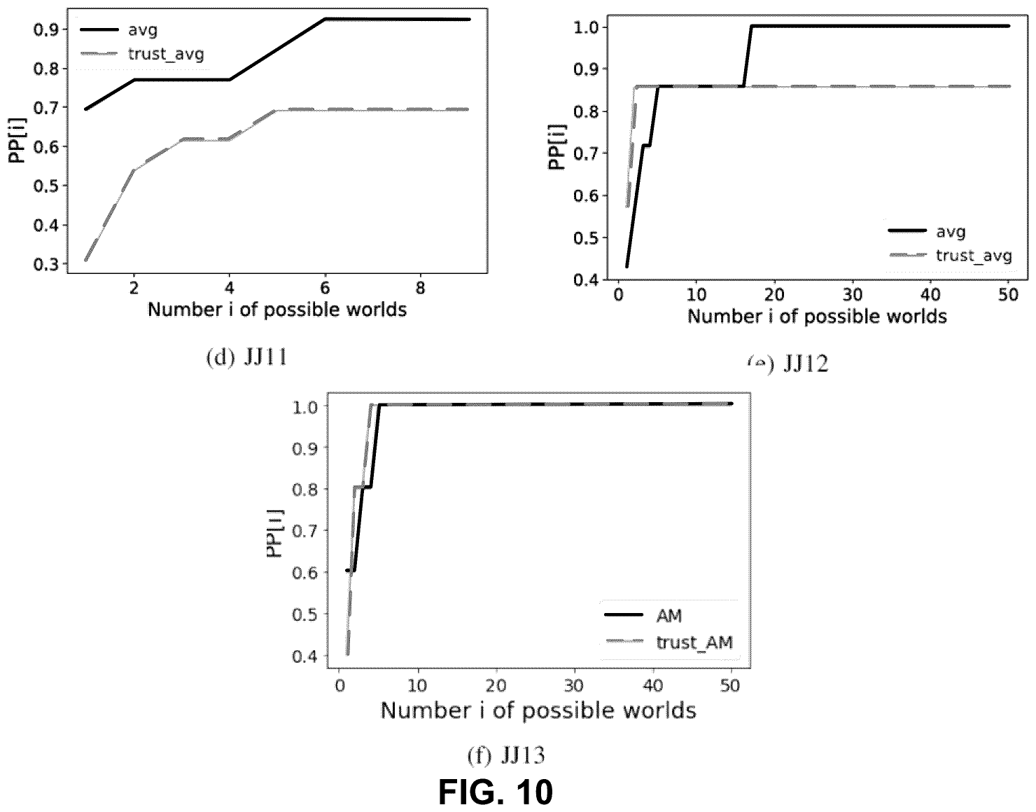

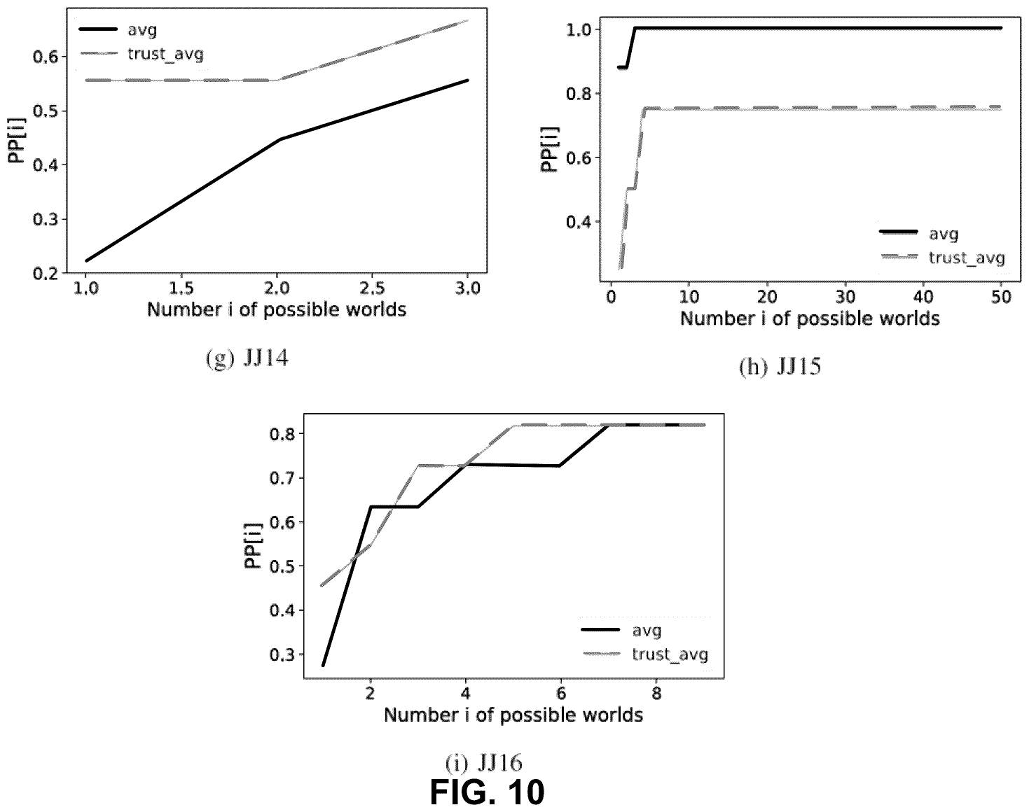

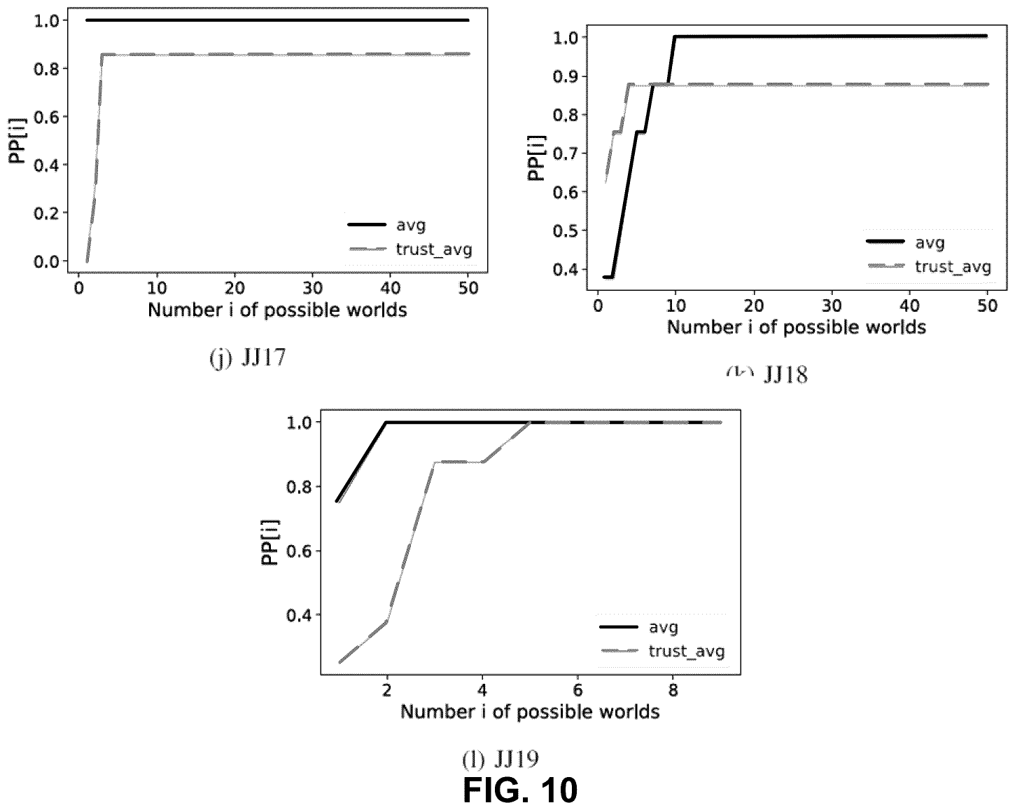

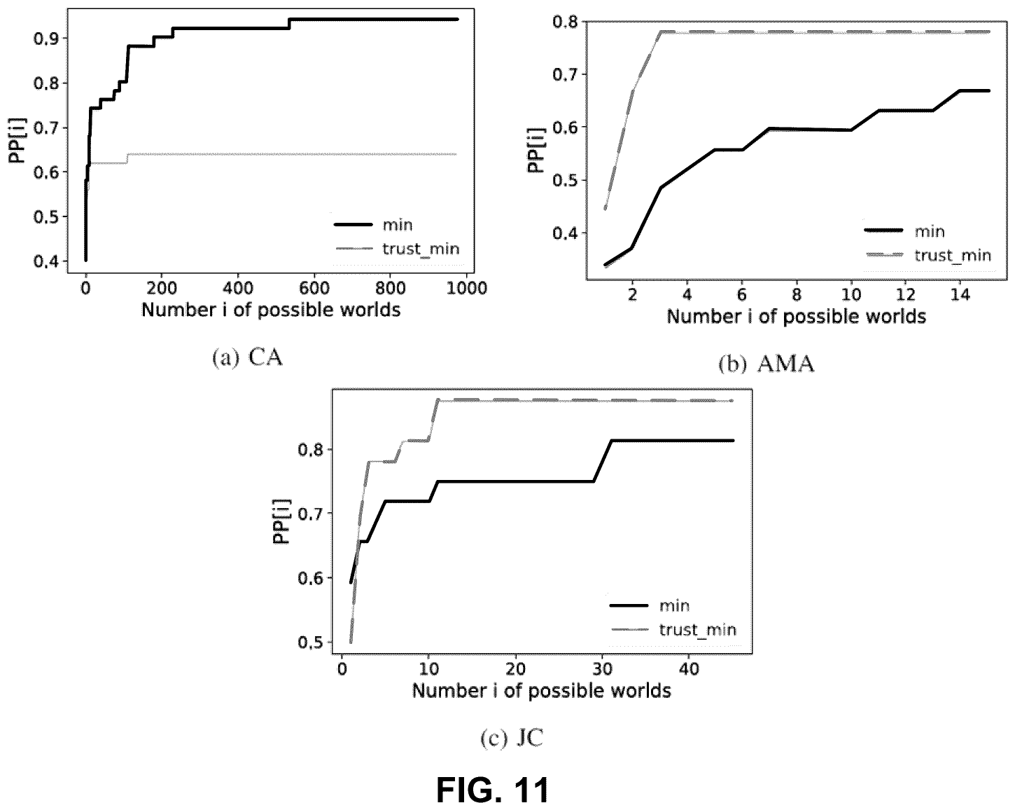

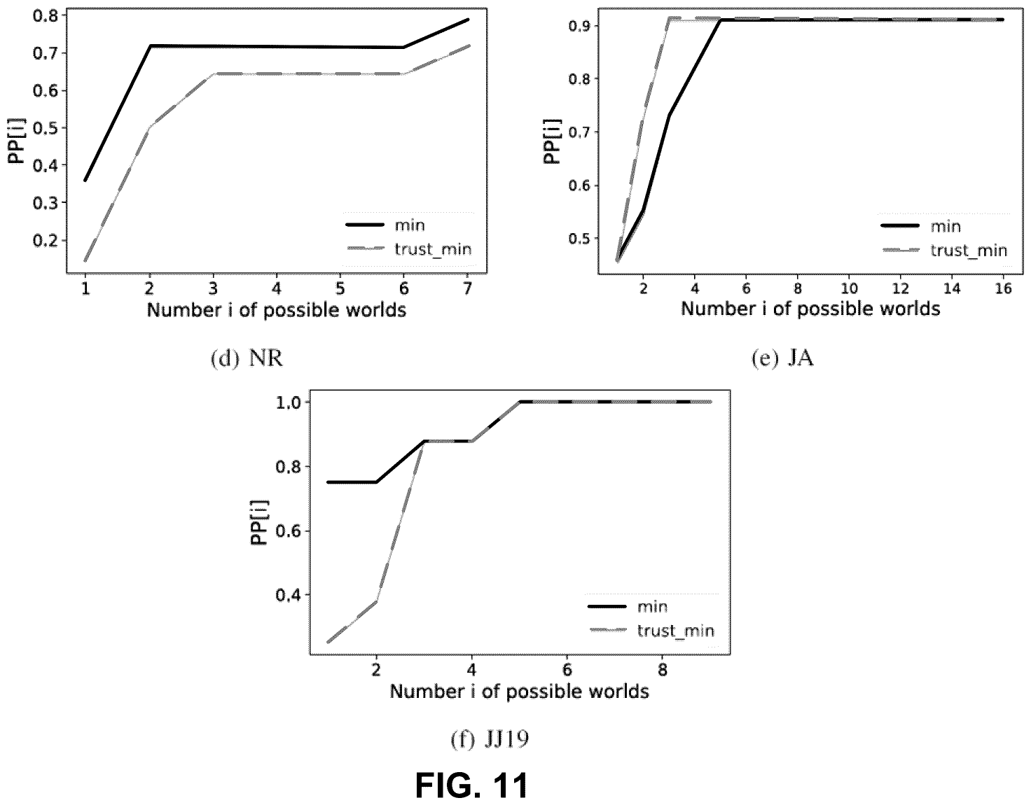

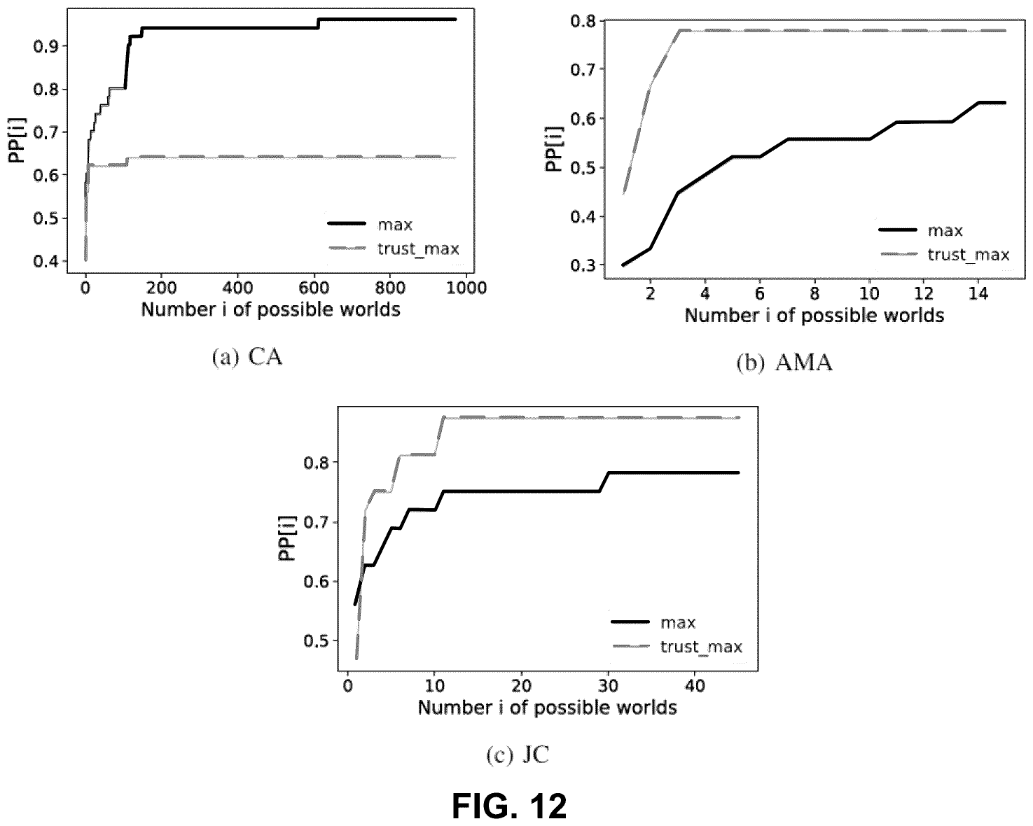

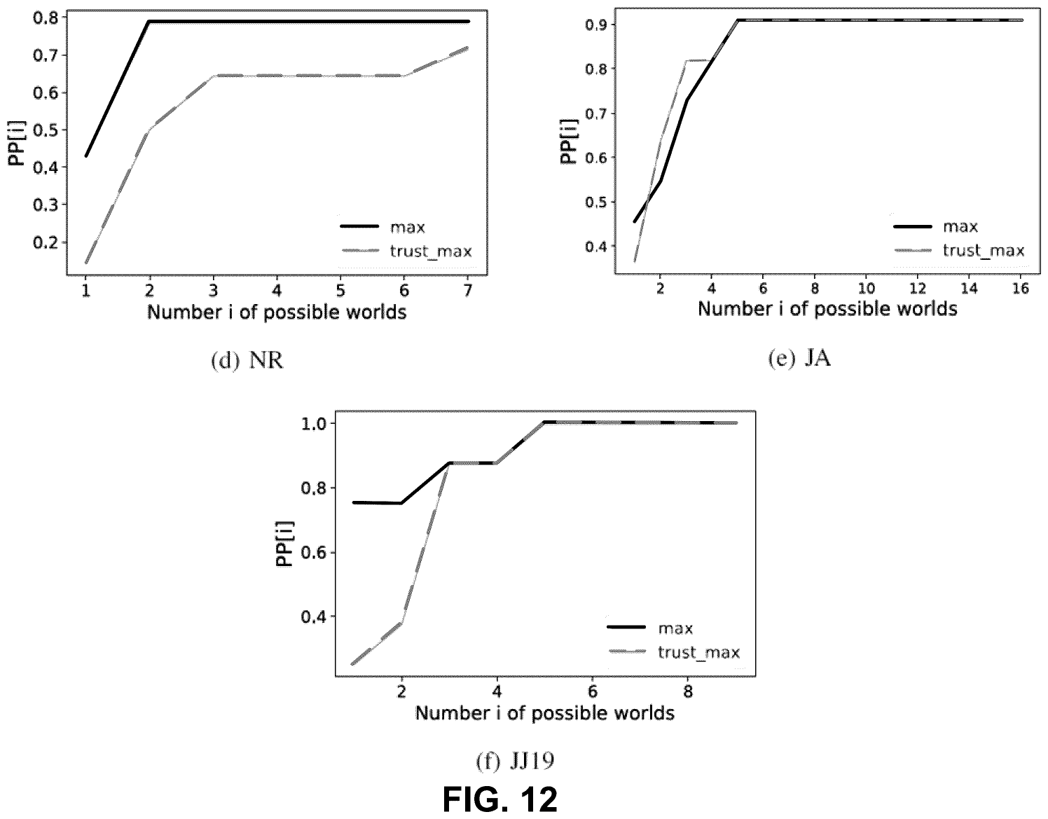

FIGS. 7-12 report the prediction performance of JUST^{imp} over all datasets considered, comparing cf_{Φ} against cf_{Φ}^{trust}, for each Φ∈{avg, min, max, mode, median}. The figures show how the prediction performance varies as an increasing number of most likely possible worlds are taken into account. Results for the datasets JJ1-JJ18 are not reported in FIGS. 9-12 because they are the same as those reported in FIGS. 7 and 8.

### Computing Platform

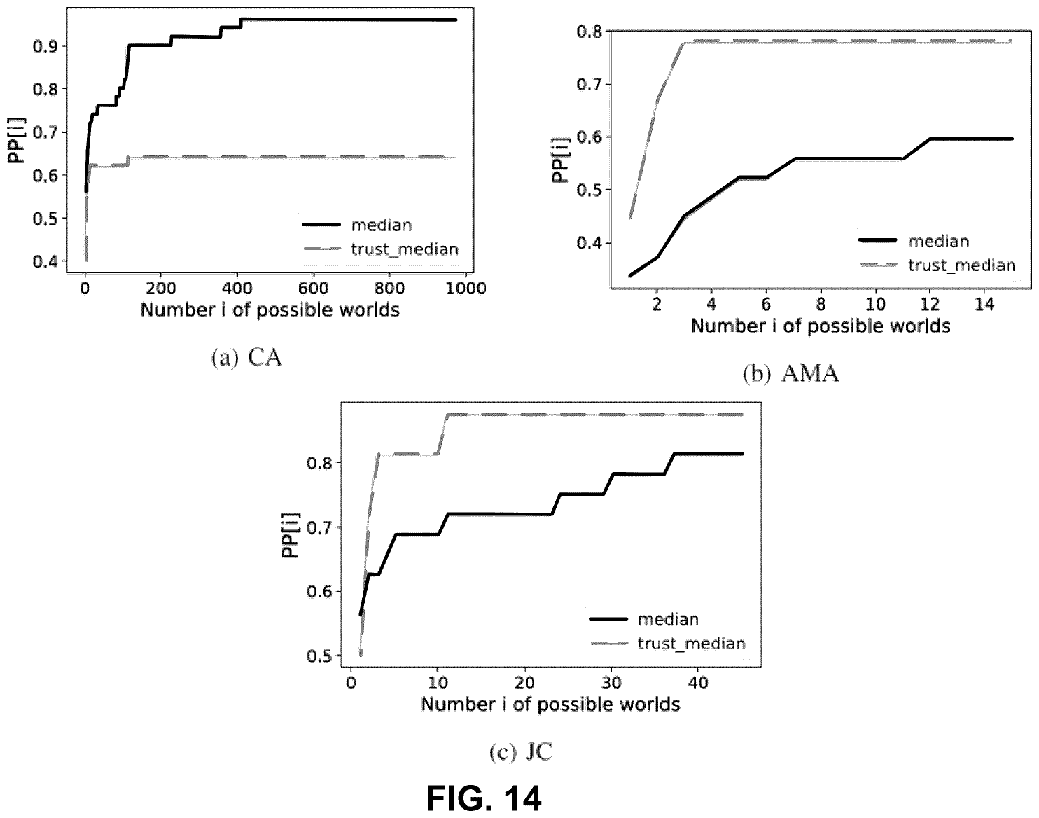

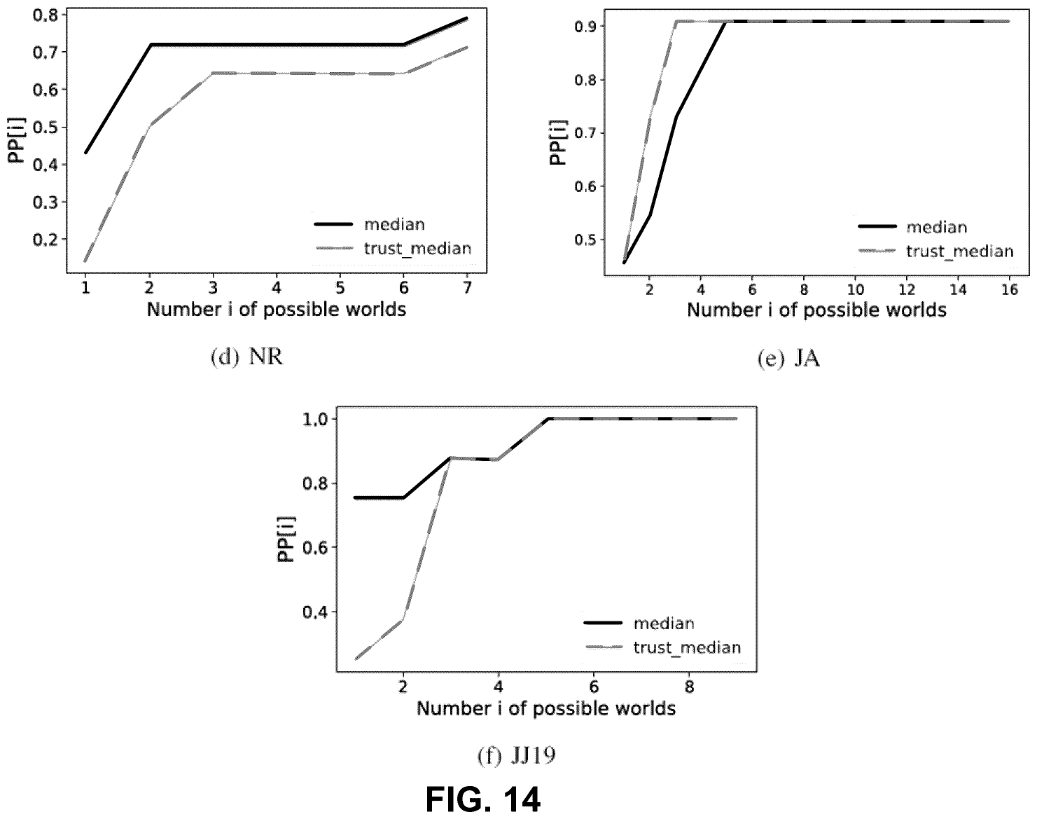

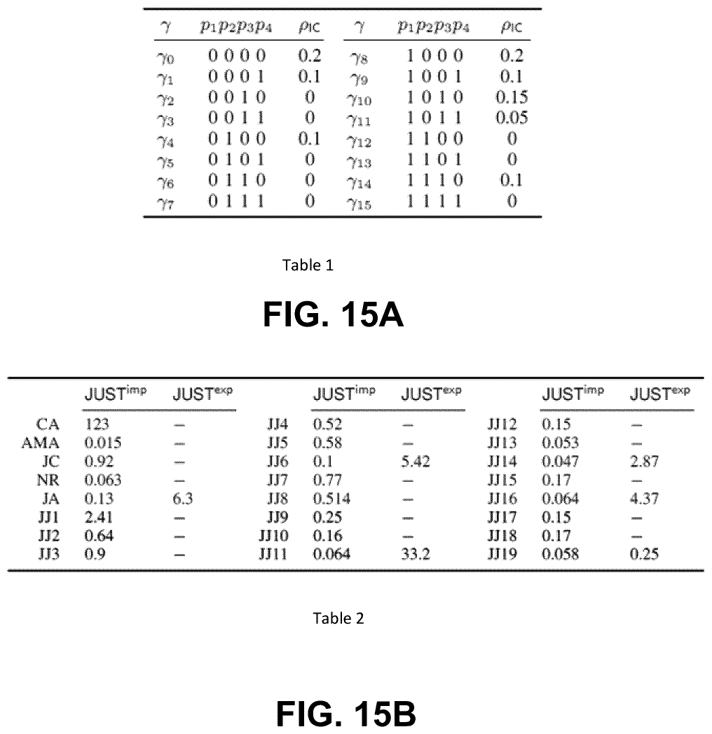

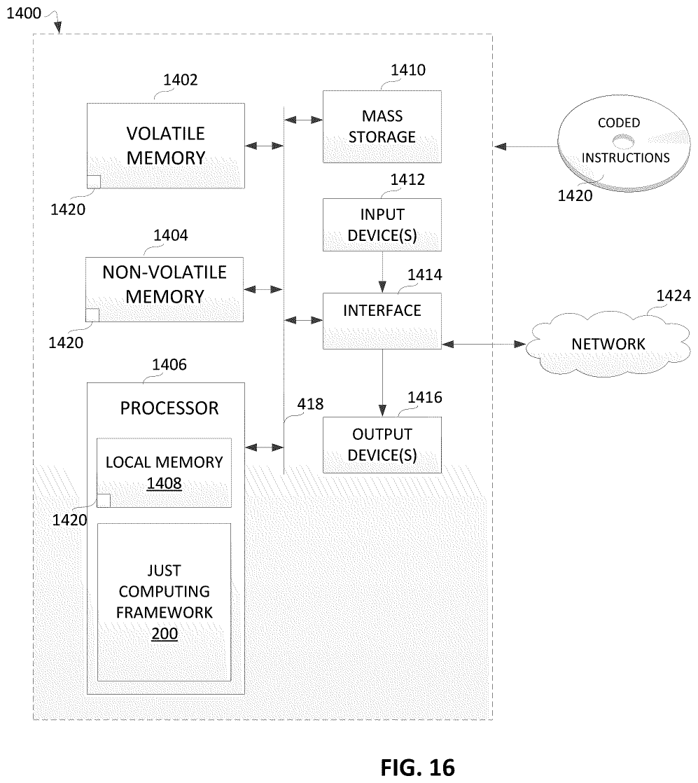

FIG. 16 shows a block diagram of an illustrative processor platform 1400 structured to execute the instructions associated with the preceding figures to implement the illustrative components discussed and described herein with respect to FIGS. 1-15B. The processor platform 1400 may be, for example, a server, a personal computer, a mobile device (e.g., a cell phone, a smart phone, a tablet), a personal digital assistant (PDA), an Internet appliance, or any other type of computing device.

The processor platform 1400 of the illustrated example includes a processor 1406. The processor 1406 of the illustrated example is hardware. For example, the processor 1406 can be implemented by integrated circuits, logic circuits, microprocessors or controllers from any desired family or manufacture and may be distributed over one or more computing devices.

The processor 1406 of the illustrated example includes a local memory 1408 (e.g., a cache memory device). The illustrative processor 1406 of FIG. 16 executes the instructions of at least the discussed algorithms and FIG. 1 to implement the systems and infrastructure and associated methods of FIGS. 1-15B such as the illustrative JUST computing framework, etc. The processor 1406 of the illustrated example is in communication with a main memory including a volatile memory 1402 and a non-volatile memory 1404 via a bus 1418. The volatile memory 1402 may be implemented by Synchronous Dynamic Random-Access Memory (SDRAM), Dynamic Random-Access Memory (DRAM), RAMBUS Dynamic Random Access Memory (RDRAM) and/or any other type of random access memory device. The non-volatile memory 1404 may be implemented by flash memory and/or any other desired type of memory device. Access to the main memory 1402, 1404 is controlled by a clock controller.

The processor platform 1400 of the illustrated example also includes an interface circuit 1414. The interface circuit 1414 may be implemented by any type of interface standard, such as an Ethernet interface, a universal serial bus (USB), and/or a PCI express interface.

In the illustrated example, one or more input devices 1412 are connected to the interface circuit 1414. The input device(s) 1412 permit(s) a user to enter data and commands into the processor 1406. The input device(s) can be implemented by, for example, a sensor, a microphone, a camera (still or video), a keyboard, a button, a mouse, a touchscreen, a track-pad, a trackball, and/or a voice recognition system.

One or more output devices 1416 are also connected to the interface circuit 1414 of the illustrated example. The output devices 1416 can be implemented, for example, by display devices (e.g., a light emitting diode (LED), an organic light emitting diode (OLED), a liquid crystal display, a cathode ray tube display (CRT), a touchscreen, a tactile output device, and/or speakers). The interface circuit 1414 of the illustrated example, thus, typically includes a graphics driver card, a graphics driver chip, or a graphics driver processor.

The interface circuit 1414 of the illustrated example also includes a communication device such as a transmitter, a receiver, a transceiver, a modem and/or network interface card to facilitate exchange of data with external machines (e.g., computing devices of any kind) via a network 1424 (e.g., an Ethernet connection, a digital subscriber line (DSL), a telephone line, coaxial cable, a cellular telephone system, etc.).

The processor platform 1400 of the illustrated example also includes one or more mass storage devices 1410 for storing software and/or data. Examples of such mass storage devices 1410 include floppy disk drives, hard drive disks, compact disk drives, Blu-ray disk drives, RAID systems, and digital versatile disk (DVD) drives.

The coded instructions 1420 of FIG. 16 may be stored in the mass storage device 1410, in the volatile memory 1402, in the non-volatile memory 1404, and/or on a removable tangible computer readable storage medium such as a CD or DVD. Data processed by the instructions and/or resulting from the processed instructions may be stored in one or more memory devices, such as the mass storage device 1410, in the volatile memory 1402, in the non-volatile memory 1404, and/or on a removable tangible computer readable storage medium.

From the foregoing, it will be appreciated that the above disclosed methods, apparatus, and articles of manufacture have been disclosed to improve the functioning of a computer and/or computing device and improving analysis and computing probabilities associated with veracity of propositions in a legal matter.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and methods which, although not explicitly shown or described herein, embody the principles of the disclosure and are thus within the spirit and scope of the present disclosure. From the above description and drawings, it will be understood by those of ordinary skill in the art that the particular embodiments shown and described are for purposes of illustrations only and are not intended to limit the scope of the present disclosure. References to details of particular embodiments are not intended to limit the scope of the disclosure.

What is claimed is:

1. A computing platform comprising:
a processor; and
a non-transitory computer-readable medium storing instructions that, when executed by the processor, cause the computing platform to:
aggregate data elements from a first plurality of sources, wherein each data element comprises a text string;
present, via a user interface, each data element of a first plurality of data elements associated with the first plurality of sources;
soliciting, for each data element of the first plurality of data elements and via the user interface, feedback corresponding to a perceived veracity of contents of each data element;
processing, using a combination function, a second plurality of data elements extracted from the first plurality of data elements;
generating, a trust score associated with the second plurality of data elements; and.
communicating, via the user interface, the trust score.

2. The computing platform of claim 1, wherein the combination function comprises an explicit function that computes an average probability of each possible world over a sample of solutions of linear constraints and returns a top-k set of most likely worlds.

3. The computing platform of claim 1, wherein the combination function comprises an implicit function that computes an expected probability of possible worlds under an independence assumption and combines the expected probability with a computed probability that a world lies in a subset of worlds.

4. The computing platform of claim 1, wherein the combination function comprises a dynamic programming algorithm running in pseudo-polynomial time.

5. The computing platform of claim 4, wherein the instructions further cause the computing platform to processes, by the combination function, each proposition of a plurality of propositions independently and iteratively processes the remaining propositions of the plurality of propositions independently.

6. The computing platform of claim 1, wherein the instructions further cause the computing platform to associate a veracity value to a proposition, wherein the proposition is associated with a third plurality of data elements of the first plurality of data elements.

7. The computing platform of claim 1, wherein the combination function utilizes a set of integrity constraints associated with the first plurality of data elements.

8. The computing platform of claim 1, wherein the data elements comprise witness statements.

9. A method comprising:
aggregating witness statements from a first plurality of sources;
presenting, via a user interface, each witness statement of a first plurality of witness statements;
soliciting, for each witness statement of a first plurality of witness statements and via the user interface, feedback corresponding to a perceived veracity of each witness statement;
processing, using a combination function, a second plurality of witness statements of the first plurality of witness statements;
generating, a trust score associated with the second plurality of witness statements; and.
communicating, via the user interface, the trust score.

10. The method of claim 9, wherein the combination function comprises an explicit function that computes an average probability of each possible world over a sample of solutions of linear constraints and returns a top-k set of most likely worlds.

11. The method of claim 9, wherein the combination function comprises an implicit function that computes an expected probability of possible worlds under an independence assumption and combines the expected probability with a computed probability that a world lies in a subset of worlds.

12. The method of claim 9, wherein the combination function comprises a dynamic programming algorithm running in pseudo-polynomial time.

13. The method of claim 12, wherein the combination function processes each proposition of a plurality of propositions independently and iteratively processes the remaining propositions of the plurality of propositions independently.

14. The method of claim 9, wherein soliciting feedback comprises associating a veracity value to a proposition, wherein the proposition is associated with a third plurality of witness statements of the first plurality of witness statements.

15. The method of claim 9, wherein the combination function utilizes a set of integrity constraints associated with the first plurality of witness statements.

16. A non-transitory computer-readable medium storing instructions that, when executed by a processor, cause a computing platform to:
aggregate data elements from a first plurality of sources, wherein each data element comprises a text string;
present, via a user interface, each data element of a first plurality of data elements associated with the first plurality of sources;
soliciting, for each data element of the first plurality of data elements and via the user interface, feedback corresponding to a perceived veracity of contents of each data element;
processing, using a combination function, a second plurality of data elements extracted from the first plurality of data elements;
generating, a trust score associated with the second plurality of data elements; and.
communicating, via the user interface, the trust score.

17. The non-transitory computer-readable medium of claim 16, wherein the combination function comprises an explicit function that computes an average probability of each possible world over a sample of solutions of linear constraints and returns a top-k set of most likely worlds.

18. The non-transitory computer-readable medium of claim 16, wherein the combination function comprises an implicit function that computes an expected probability of possible worlds under an independence assumption and combines the expected probability with a computed probability that a world lies in a subset of worlds.

19. The non-transitory computer-readable medium of claim 16, wherein the combination function comprises a dynamic programming algorithm running in pseudo-polynomial time.

20. The non-transitory computer-readable medium of claim 19, wherein the instructions further cause the computing platform to processes, by the combination function, each proposition of a plurality of propositions independently and iteratively processes the remaining propositions of the plurality of propositions independently.
